(19) United States
(12) Patent Application Publication
(10) Pub. No.: US 2011/0191087 A1
(43) Pub. Date: Aug. 4, 2011

(54) COMPUTER IMPLEMENTED MODEL OF BIOLOGICAL NETWORKS

(75) Inventors: Hans Lehrach, Berlin (DE); Ralf Herwig, Gross Gilenicke (DE); Christoph Wierling, Berlin (DE)

(73) Assignee: Max-Planck-Gesellschaft zur Forderung der Wissenschaften e.V., Munchen (DE)

(21) Appl. No.: 13/061,975

(22) PCT Filed: Sep. 3, 2009
(86) PCT No.: PCT/EP2009/007223

§ 371 Date: Apr. 19, 2011

(30) Foreign Application Priority Data
Sep. 3, 2008 (EP) 08015557.5

(51) Int. Cl. G06G 7/48

(52) U.S. Cl. 703/11

(57) ABSTRACT

The present invention relates to a computer-implemented method of producing a kinetic model of a biological network, the method comprising (a) choosing a network topology, wherein the nodes of said topology represent biological entities and the edges of said topology represent interactions between said entities; (b) assigning kinetic laws and kinetic constants to said interactions; and (c) assigning starting concentrations to said biological entities, wherein (i) one part of said kinetic constants and independently one part of said starting concentrations are experimental data; and (ii) the remaining part of said kinetic constants and independently the remaining part of said starting concentrations are chosen randomly.

### CROSS REFERENCE TO RELATED APPLICATIONS

This application is a 35 U.S.C. §371 U.S. National Phase Entry of International Application No. PCT/EP2009/007223 filed Sep. 3, 2009, which designates the U.S., and which claims the benefit of priority of European Application No. 08 01 5557.5 filed Sep. 3, 2008, the contents of which are each incorporated herein by reference in its entirety.

### DETAILED DESCRIPTION

This invention relates to computer-implemented method of producing a kinetic model of a biological network, the method comprising (a) choosing a network topology, wherein the nodes of said topology represent biological entities and the edges of said topology represent interactions between said entities; (b) assigning kinetic laws and kinetic constants to said interactions; and (c) assigning starting concentrations to said biological entities, wherein (i) one part of said kinetic constants and independently one part of said starting concentrations are experimental data; and (ii) the remaining part of said kinetic constants and independently the remaining part of said starting concentrations are chosen randomly.

In this specification, a number of documents including patent applications and manufacturer's manuals are cited. The disclosure of these documents, while not considered relevant for the patentability of this invention, is herewith incorporated by reference in its entirety. More specifically, all referenced documents are incorporated by reference to the same extent as if each individual document was specifically and individually indicated to be incorporated by reference in its entirety in this document.

In silico biology permits the simulation of biological systems of ever increasing complexity. It holds the potential of providing detailed insight into disease-relevant processes, of accelerating the drug development process and of predicting responses to medical treatment. However, limited experimental data is the main bottleneck in creating detailed dynamic models of biological processes. While the molecules involved in biological pathways, networks and processes are frequently known to a large extent, this does not in many cases apply to the kinetic constants quantitatively describing the interactions between these molecules. Estimating unknown parameters is not considered satisfactory, since estimation may be arbitrary and introduce bias into the model.

The technical problem underlying the present invention is the provision of means and methods for predicting the time-dependent behavior of biological systems, in particular in those cases where experimental data are not sufficient to parameterize the model.

Accordingly, this invention relates to computer-implemented method of producing a kinetic model of a biological network, the method comprising (a) choosing a network topology, wherein the nodes of said topology represent biological entities and the edges of said topology represent interactions between said entities; (b) assigning kinetic laws and kinetic constants to said interactions; and (c) assigning starting concentrations to said biological entities, wherein (i) one part of said kinetic constants and independently one part of said starting concentrations are experimental data; and (ii) the remaining part of said kinetic constants and independently the remaining part of said starting concentrations are chosen randomly.

The term “model” as used herein refers to an in silico representation of a biological system. A “kinetic model” is a model capable of describing the time-dependent behavior of a biological system. Necessary ingredients for predicting the time-dependent behavior include kinetic laws and associated kinetic constants governing the interactions between constituents of the biological system including the conversion of constituents of the biological system. These constituents are herein also referred to as “biological entities”. The term “biological entity” comprises any molecule which may occur in a biological system. Preferred biological entities are biomolecules which are further detailed below. The constituent biological entities render the model an in silico representation of a biological system. The model according to the invention furthermore comprises starting concentrations of the biological entities. Kinetic laws, kinetic constants and starting concentrations together permit the prediction of the time dependent behavior of said biological network. The term “assigning” refers to fixing or setting certain properties or numeric values at the beginning of the simulation. While kinetic laws and kinetic constants preferably do not change during the simulation, it is self-evident that concentrations of the biological entities as assumed during the simulation may differ from the respective starting concentrations. The biological systems this invention pertains to are biological networks. Preferred biological networks include all intra-cellular interaction networks, examples of which are signaling networks, transcriptional control networks, metabolic networks, sensory and homeostatic networks, degradational networks, regulatory networks and combinations thereof.

Preferred biological networks also include all inter-cellular interaction networks mediated by e.g. receptor-ligand action, permeable contacts like tight junctions, host-pathogen interactions as well as any other interactions between cells or organisms, examples of which are cellular growth and differentiation networks, angiogenic networks, wound healing networks, inflammatory and immune response networks as well as the complex networks of inter-cellular or inter-organismal interaction that result in functioning tissues, organs, organisms and organismal communities.

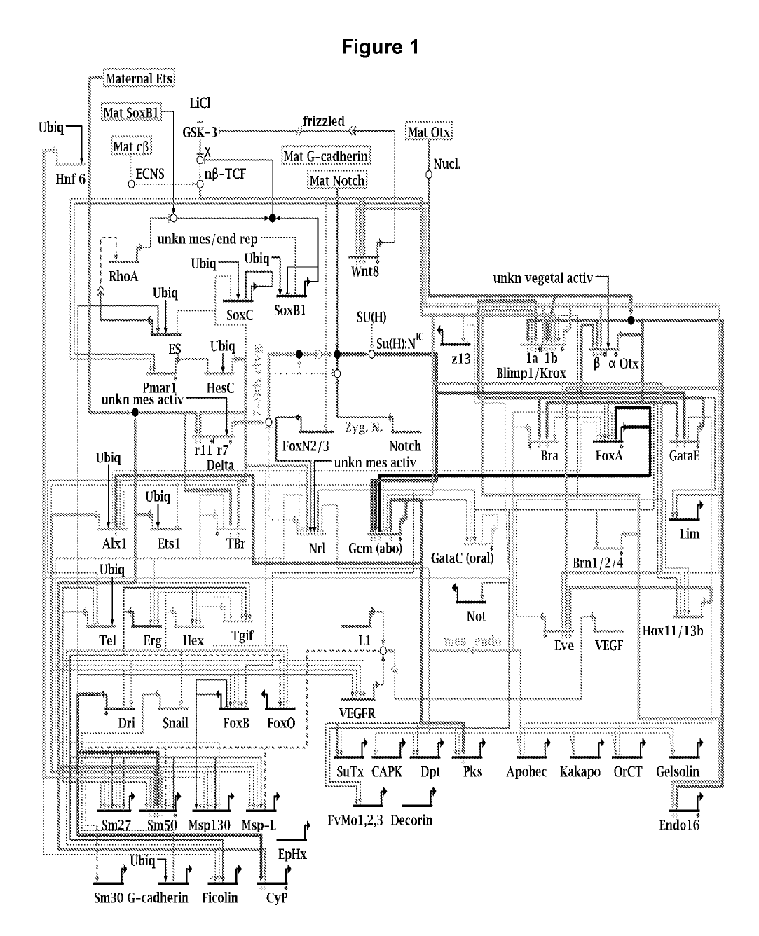

Networks may also be referred to and represented as “graphs”. An Example of a network or graph is shown in FIG. 1 enclosed herewith. More specifically, and as well known in the art, a network or graph comprises nodes and edges. Nodes and edges together form the topology of the network. The nodes of said network are the in silico counterparts of the above mentioned biological entities and the edges of said network are the in silico counterparts of interactions between the above mentioned entities. The term “interactions” as used herein refers to any kind of interactions, in particular to those interactions which may affect the amounts or concentrations of the biological entities involved in said interaction. More specifically, the term “interaction” includes conversion of one or more given biological entities into one or more different biological entities, possibly under the influence of one or more further biological entities. Other preferred interactions include decrease or increase of the amount or concentration of one or more biological entities, for example as a consequence of the action, presence or absence of one or more other biological entities. Yet another preferred interaction is the formation of a complex from two or more biological entities.

In other words, the interactions according to the invention involve or entail reactions. Reactions according to the invention may be modeled using mass action kinetics but can, in general, follow any other suitable kinetic law. As is well-known in the art, mass action kinetics depends on the concentrations of the biological entities involved in a given reaction and the kinetic constants; for details see below.

According to the prior art, modeling the kinetics of a biological system requires knowledge of all kinetic laws, kinetic constants and starting concentrations of all involved biological entities or reactants. According to the present invention, kinetic models are provided, wherein only one part of the kinetic constants and only one part of the starting concentrations are experimental data or derived from experimental data, wherein the remaining part of the kinetic constants and independently the remaining part of the starting concentrations is chosen randomly, i.e., without relying on experimental data. This approach is also referred to as the Monte Carlo approach.

Experimental data suitable for determining kinetic constants include time courses of the biological entities involved in an interaction. However, and as stated above, such information is either not available or difficult to generate for many interactions in biological networks. Experimental data for the starting concentrations may be obtained by performing measurements in the naturally occurring counterpart of the biological network to be simulated, i.e. for example in cells.

The use of known kinetic constants and known starting concentrations is independent of each other. Accordingly, the present invention comprises embodiments wherein all starting concentrations are experimental data and a part of said kinetic constants is chosen randomly, as well as embodiments wherein all kinetic constants are experimental data and a part of said starting concentrations is chosen randomly.

Surprisingly, the present inventors realized that biological networks are robust as regards the particular choice of the kinetic constants in those cases where a fraction or even all of the kinetic constants are not known. This applies in particular to the steady states and equilibria assumed by the biological networks. In particular, it turns out that even in the absence of any experimental data defining the kinetic constants the time-dependent behavior of a biological network generates reproducible predictions to an extent which by far exceeds predictions by chance. In this regard, we refer to the method of determining the statistical significance of in silico models which is further detailed below. The same observations and considerations apply mutatis mutandis to partial or complete absence of experimentally known starting concentrations.

The present invention furthermore relates to a method of predicting concentrations of biological entities as a function of time in a biological network, said method comprising producing a model of a biological network by the method according to main embodiment; and (d) solving a system of differential equations, said differential equations defining the time-dependency of the concentrations of said biological entities; thereby obtaining said concentrations as a function of time.

Representing the time-dependency of amounts or concentrations of biological entities or reactants by differential equations, more specifically by ordinary differential equations (ODE) is well-known in the art.

More specifically, the interactions controlling the amount or concentration of one biological entity may generally be modeled in the following way: Consider a biological entity with two positive inputs, A₁ and A₂, and one inhibitory input, I₁. Any of the positive inputs is sufficient to increase the amount or concentration (A₁ V A₂) while the activity of one inhibitory input is sufficient to decrease the amount or concentration of the target ((A₁ V A₂) Λ [symbol] I₁). In some cases, other ways of defining interaction may be favored based on network topology and experimental data. The interactions in this notation are formulated in a Boolean way.

For the ODE model, mass action kinetics is used. Interactions such as degradation, transport, signaling and complex association/dissociation as well as translational and post-translational processes were modeled using mass-action kinetics of the form

v_{reaction}=k_{reaction}·IIᵢ₌₀^{|substrates|}[Substrateᵢ]

For each group of reactions mentioned above, one ubiquitous parameter k_{reactiongroup} was used.

To transfer the formulation of the Boolean model to rate laws, the approach derived from [28] may be used. In particular the following elementary modules may be used:

$${ϕ}_{{G}_{A}} = \frac{{k}_{{A}_{G}} \cdot [ A ]}{{c}_{{A}_{G}} + [ A ]} \qquad ( 1 )$$

for positive inputs A on an entity G and

$${ϕ}_{{G}_{I}} = \frac{{k}_{{I}_{G}} \cdot {c}_{{I}_{G}}}{{c}_{{I}_{G}} + [ I ]} \qquad ( 2 )$$

for negative inputs I. The constants c_{X} and k_{X} represent individual features of the regulatory role of each entity, where k_{X} corresponds to the strength of activation in absence of the inhibitor whereas c_{X} determines the amount or concentration of input necessary to generate a significant change in activity. The elementary modules can be combined to formulate complex interactions, including regulatory interactions. This is done using multiplication (corresponding to Boolean AND) or addition (corresponding to Boolean OR).

The example mentioned above with two activators and one inhibitor thus reads:

$${}^{v} translation = ( {}^{k} A 1 \cdot [ A 1 ] \\ {}^{v} translation = ( \frac{{k}_{{A}_{1}} \cdot [ {A}_{1} ]}{{c}_{{A}_{1}} + [ {A}_{1} ]} + \frac{{k}_{{A}_{2}} \cdot [ {A}_{2} ]}{{c}_{{A}_{2}} + [ {A}_{2} ]} ) \cdot \frac{{k}_{{I}_{1}} \cdot {c}_{{I}_{1}}}{{c}_{{I}_{1}} + [ {I}_{1} ]} \qquad ( 3 )$$

assuming the model relates to gene expression.

The ODE model uses events to turn external inputs on and off. Instead of changing a concentration directly, one may use activating and inhibitory Hill kinetics for the description of the external inputs. These kinetics do not depend on some activator or inhibitor but on the simulation time. The change in concentration of an external input is given by the following differential equation:

$$\frac{d [ x ]}{d t} = {S}_{1} \cdot k \cdot \frac{{t}^{h}}{{Θ}^{h} + {t}^{h}} + ( 1 - {S}_{1} ) \cdot k \cdot ( 1 - \frac{{t}^{h}}{{Θ}^{h} + {t}^{h}} ) - {k}_{deg} \cdot [ x ] \qquad ( 4 )$$

where k_{deg}·[x] is a degradation term. Since S₁ε0, 1, only one of the two other terms is not equal 0. Thus, by changing Θ and S₁, an external input is activated (in the case that S₁=1) at time point Θ or inactivated at time point Θ (when S₁=0). By changing S₁ and Θ using events, the activity of the external inputs may be controlled.

The mathematical concepts and the methodology underlying the present invention are also described in detail in the publication Kuhn et al. (2009). The publication Kühn et al. (2009), and in the present context in particular the section entitled “Methods” of Kühn et al. (2009), is fully incorporated by reference.

In a preferred embodiment of the method of the invention, said remaining part of said kinetic constants is chosen from a probability distribution and independently said remaining part of said starting concentrations is chosen from a probability distribution. The respective probability distributions may be the same or different.

The term “probability distribution” or “probability density function” is well known in the art. It associates a particular event, in the present case a particular value of kinetic constants or a particular value of a starting concentration, with the probability of its occurrence. The kinetic constants are sampled randomly from the probability distributions chosen for each kinetic constant, reflecting the degree of knowledge available for each. Independently, the starting concentrations are sampled randomly from the probability distributions chosen for the starting concentrations. The same or different probability distributions may be used for choosing starting concentrations in those cases where the starting concentrations of more than one biological entity are to be chosen, again reflecting the partial (or complete) knowledge available. To explain further, in the absence of any prior knowledge, the probability distributions are preferably the same for all unknown parameters, the term “parameter” including kinetic constants and starting concentrations. In case there is only limited or approximate knowledge or knowledge from analogous interactions available, the kind of knowledge may be taken into account by a scaling factor and/or a modified breadth of the distribution function in order to reflect such type of information. In addition, and as further detailed below, kinetic laws can be chosen randomly, preferably with probabilities again depending on available knowledge. Generally speaking, this forward method of the invention is distinct from the well-known process of parameter estimation. In parameter estimation the model parameters are estimated by mathematical methods for the purpose of determining an optimal parameter set that fits the observation. In the proposed approach the parameters are repeatedly randomly chosen and the significance of the generated observations is judged with statistical methods.

In a preferred embodiment, said distribution is a lognormal distribution. In a lognormal distribution, the logarithms of the kinetic constants are distributed normally, i.e., they follow a Gaussian distribution. The appropriateness of the probability distribution depends on the application and the prior knowledge in the field. Further appropriate probability distributions include the uniform, exponential, Poisson, Binomial, Cauchy, Beta and Gaussian probability distributions.

In a further preferred embodiment of the method of predicting concentrations of biological entities according to the invention, randomly choosing said remaining part of said kinetic constants, randomly choosing said remaining part of said starting concentrations, and subsequently solving said system of differential equation is performed repeatedly.

This embodiment permits an assessment of the response of the biological network to different sets of kinetic constants, which in turn are randomly chosen for at least part thereof. It has surprisingly been found and documented in the examples herewith that the kinetic behavior of the biological network is dependent on a limited number of parameters and that different random choices of most kinetic constants, while exerting a certain influence on the time-dependent behavior of the biological network, do not fundamentally alter said time-dependent behavior, in particular not the steady states or equilibrium states.

It is particularly surprising, that even in the complete absence of experimentally determined kinetic constants and/or in the complete absence of experimental determined starting concentrations, reproducible predictions can be achieved with sufficient Monte Carlo modeling and that these predictions can be verified by existing knowledge. In other words, it is deliberately envisaged that the number of kinetic constants which are experimental data is zero, the consequence being that all kinetic constants defining the interactions in the biological network are chosen randomly. Without being bound by a specific theory it is considered that the particular topology of the biological network, i.e., the nodes and connections between the nodes (disregarding the kinetic constants associated with the connections between the nodes) limits the space of potential outcomes to the extent that repetitive Monte-Carlo modeling allows effective exploration of the space of time dependent outcomes of the system.

In a preferred embodiment the random selection of kinetic constants and the solution of the ordinary differential equation systems is done multiple times, ideally as many times as is feasible, limited by the available computational hardware. In our experience we find 10-1000 runs to be optimal based on current computational limitations but we also find that additional incremental value in the form of increased accuracy continues to be generated with runs of 10,000 or more.

In a preferred embodiment all available experimentally derived kinetic constants and starting concentrations are used in simulation, in general in the inventors' experience known kinetic constants generally improve the accuracy of the simulation. However, in another preferred embodiment certain known kinetic constants are selectively replaced with kinetic constants selected from a probability distribution. This may be done in case of concerns about the accuracy of the experimentally derived constants or when the experimentally derived constants prevent the system from reaching a steady state.

In a further preferred embodiment the kinetic constants and starting concentrations of biological entities for a simulation of a particular biological system are derived from previous simulations with similar systems. Similar systems refer to systems that are close to the system under analysis, for example the same biological system but with a particular perturbation. The term “perturbation” is defined further below. Previous simulations are carried out with multiple parameter sets to reach steady states. Then, a subset of these steady states is selected according to biological knowledge. Biological knowledge refers to known model predictions that can be reproduced by the model and known parameter values. Those subsets of parameter sets are then used for the simulation.

In a further preferred embodiment the kinetic constants are estimated by appropriate methods prior to the simulation.

In a preferred embodiment, at least 10%, at least 20%, at least 30%, at least 40% or at least 50% of said kinetic constants and independently of said starting concentrations are experimental data. Obviously, it is also envisaged to use at least 60%, at least 70%, at least 80% or at least 90% kinetic constants which are experimental data.

In a further preferred embodiment of the methods of the invention, furthermore one part of said kinetic laws is known, and the remaining part of said kinetic laws is chosen randomly.

This embodiment extends to situations, wherein, in addition to unknown kinetic constants and/or unknown starting concentrations, the kinetic laws governing the interactions between the biological entities of the model are partly unknown. The randomly choosing of kinetic laws may be performed from a discrete probability distribution. The probability distribution is discrete as a consequence of the kinetic law being a discrete variable. To explain further, in case the kinetic law for the conversion of biological entity A into biological entity B is unknown, the kinetic law may be chosen from a probability distribution which provides a 50% probability for a first-order kinetic law and a 50% probability for a second-order kinetic law. Of course, and as stated above, advantage may be taken from knowledge which is approximate or derived from analogous interactions. In other words, if it is know that in analogous cases 90% of the interactions are governed by a first-order kinetic law and 10% by a second-order kinetic law, the distribution may provide a 90% probability for a first-order kinetic law and a 10% probability for a second-order kinetic law.

In a more preferred embodiment, at least 10%, at least 20%, at least 30%, at least 40% or at least 50% of said kinetic laws are derived from experimental data. Obviously, it is also envisaged to use at least 60%, at least 70%, at least 80% or at least 90% kinetic laws which are derived from experimental data.

In a further preferred embodiment of the method of predicting concentrations of biological entities according to the invention, (e) said method is concomitantly performed on one or more further biological networks; and (f) the concentrations of biological entities are exchanged between the biological networks at chosen time points. The amount or concentration of one biological entity, or the amounts or concentrations of more or all biological entities may be exchanged. Preferred biological entities the amount or concentration of which is to be exchanged include inter-cellular signalling molecules such as growth factors, cytokines and hormones. “Exchanging of amounts” and “exchanging of concentrations” refers to the making available of said amounts or concentrations to one, more or all of said further biological networks. Once said amounts are made available to further biological networks, they may be used as input in said further biological networks, depending on the kinetic laws governing the interactions in said further networks.

This approach permits inter cilia to select particular variants of the network, the kinetic laws and ranges of values for the kinetic constants and starting concentrations, which are compatible with the expected behaviour of the biological system.

This embodiment of the invention permits the simulation of interactions between networks. For example, one simulated network may represent a cell, wherein a second simulated network represents a second cell, wherein the two cells are capable of exchanging information and/or biological entities. Obviously not only two, but also five, ten, hundreds or thousands of biological networks may be simulated concomitantly. Such a simulation is a simulation of a multi-cellular assembly, of a tissue, of an organ, of an entire organism or a population of interacting organisms.

Biological entities may be exchanged at every time step of the simulation or at larger intervals, for example every other, every tenth or every hundredth time steps.

In a further preferred embodiment of the methods according to the invention, the concentrations of said biological entities are perturbed as compared to the wild type.

The term “perturbed” or “perturbation” as used herein refers to deviations from the wild type. In a corresponding experimental setting, such a deviation may result from under- or overexpression of a given biological entity or from mutations. Other envisaged perturbations are caused by the administration of drugs or other substances.

In a preferred embodiment, the concentrations of biological entities in a perturbed system are experimentally determined. The perturbed system being modeled may be a cell, tissue, organ, organism or group of interacting organisms and the perturbation may be caused by a knock down experiment, by a mutation, by a disease state, or by the administration of a drug.

In preferred embodiments of a knock-down perturbation according to the invention, the concentration(s) of the biological entity or entities being knocked down are fixed to a certain percentage of their starting concentration, 10% and 0% are preferred percentages. In addition, reactions which increase or decrease the concentration of the knocked-down entities are disabled so the biological entity remains at the fixed concentration throughout the simulation. Starting concentrations of the perturbed entities are either selected from a lognormal distribution or from experimental data such as gene expression, RT-PCR, quantitative proteomic technologies and metabolomic technologies.

In preferred embodiments of a mutational perturbation according to the invention, the effect of the mutation on the biological entity is modeled as known from literature or in the event that the mutation's effects are unknown the mutation is modeled using inferences from bioinformatics technologies. For instance a silent mutation is effectively modeled by the wild type biological entity, a mis-sense mutation can be often modeled by the complete knock down (0%) of the biological entity, mutations that damage known functional domains can be modeled by removing the appropriate edge between the modeled biological entity and the biological entity the damaged domain was meant to interact with, constitutively activating mutations can be modeled by adding an artificial non-reversible reaction (edge) that converts the inactive form of the biological entity into the active form, and finally mutations which are known to change the enzymatic efficiency of an enzymatic biological entity are modeled by multiplying the kinetic constant by the known factor of change of efficiency; in all these cases the kinetic constants are either experimentally determined or are selected from a lognormal distribution.

In preferred embodiments of a disease state perturbation according to the invention, mutational perturbations known to be involved in the disease are modeled as described in the section above. In addition, active disease state data as embodied in gene expression, protein and phosphoprotein concentration, metabolite and micro-RNA levels are directly applied to the model by setting the initial concentrations of the appropriate biological entities to the levels described empirically.

In preferred embodiments of a drug administration perturbation according to the invention, the effect of the application of the drug on the biological entities the drug is known to interact with may be modeled in one of several distinct ways:
a) If the drug acts by inhibiting the activity of one or more biological entities that are enzymes, e.g. kinases, the activity is modeled by taking the experimentally defined IC50 for each kinase and applying it to the kinetic constant for the kinase by dividing the known IC50 concentration of the drug by the modeled cellular concentration of the drug and multiplying the result by 50%. The modeled cellular concentration is generally considered to be the concentration of application. For instance, to model 500 nM of drug application, the cellular concentration is generally assumed to be 500 nM. However, if factors are known about the modeled drug e.g. permeability or solubility or about the modeled cell e.g. upregulated PGP or MDR-1 that would affect drug pharmacology, the modeled cellular concentration can be set to a fraction of the applied concentration; if this is done, it is preferably based on empirical data.
b) If the drug acts by inhibiting a protein-protein interaction, then the kinetic constant of that interaction, i.e. edge, is modified by the known IC50 of the drug as in a)
c) If the drug is non-mechanistic as are most classical anti-neoplastic agents, the effect of application of the drug is modeled by turning on those biological entities in the network that are known to responsible for sensitivity and resistance to the drug. For instance, platinum based chemotherapy agents like cisplatin and carboplatin act by chelating DNA which results in the cellular DNA repair networks being hyper-stimulated. In addition cells become resistant to these drugs by overexpressing PGP and MDR-1 or by acquiring mutations in the DNA damage sensing and repair and apoptotic networks. Therefore selected biological entities in the DNA damage sensing and repair pathways can be modeled in the system as constitutively activated. In addition, the effects of non-mechanistic drugs can be modeled indirectly, based on changes in RNA and protein expression patterns. The entitites to be modeled in this way are preferably taken from gene expression or proteometric experiments of application of the real drug to real cells, although they can also be modeled from what is known about drug response from the literature.

In a further preferred embodiment of the methods of the invention, initial conditions comprise (a) experimentally determined concentrations of biological entities; and/or (b) experimentally determined mutation data.

The term “initial conditions” as used herein refers to nature, number, state and concentrations of said biological entities at the beginning of the simulation.

The present invention furthermore provides a computer-implemented method of determining the statistical significance of the method of predicting concentrations of biological entities according to the invention, said method of determining the statistical significance comprising (a) performing the method of predicting concentrations of biological entities according to the invention; (b) determining the degree of agreement between concentrations of biological entities obtained in step (a) and experimentally determined concentrations for the same biological entities; (c) randomizing the topology of said biological network; (d) performing the method of predicting concentrations of biological entities according to the invention on the randomized biological network obtained in step (b); (e) determining the degree of agreement between concentrations of biological entities obtained in step (d) and experimentally determined concentrations for the same biological entities; (f) comparing the results obtained in step (b) with those obtained in step (e), wherein a higher degree of agreement in step (b) is indicative of the method of predicting concentrations of biological entities according to the invention being capable to predict experimentally determined concentrations better than by chance.

This aspect of the invention relates to a method of validating the method of predicting concentrations of biological entities as a function of time according to the invention. It compares the effects of randomly choosing kinetic constants from a probability distribution with randomizing the topology of the biological network. Preferably, said randomizing of the biological network is effected by swapping edges of said network.

The term “swapping edges of said network” refers to an alteration of the connections in said network. For example, if edge 1 connects nodes A and B and edge 2 connects nodes C and D in the biological network used for predicting concentrations of biological entities as a function of time, an example of a network with swapped edges would be a network wherein edge 1 connections nodes A and D and edge 2 connects nodes B and C.

The above mention of “determining the degree of agreement” may be performed using time courses, if available, or using final concentrations, such as steady state or equilibrium concentrations.

In preferred embodiments, 10%, 20%, 30%, 40%, 50%, 60%, 70%, 80%, 90% of the edges or all edges are being swapped.

In a further preferred embodiment of the methods according to the invention, said entities are biomolecules, preferably selected from nucleic acids including genes; (poly)peptides including proteins; small molecules; and complexes and metabolites of biomolecules. Small molecules include saccharides, amino acids, lipids, nucleotides, nucleosides as well as metabolites and derivatives thereof.

In a further preferred embodiment of the methods according to the invention, said model comprises boundary conditions, preferably boundary conditions representing a physiological state. Boundary conditions may have an influence on the kinetic constants and/or on the connectivity of the graph.

Preferred boundary conditions include presence or homeostasis of a biological entity or stimulus. It may include presence of one or more drugs in given amounts. Other preferred boundary conditions are extra-cellular signalling gradients and boundary conditions imposed by cell-cell communication and physiological signals.

The present invention furthermore provides a computer program adapted to perform the method of any one of the preceding claims.

Furthermore provided is a computer-readable data carrier, comprising the program according to the invention. Also provided is a data processing apparatus comprising means for performing the methods according to the invention or having a program according to the invention installed thereon.

The present invention furthermore provides a computer-implemented method of determining partially unknown parameters of a biological network, said parameters being selected from network topology, kinetic laws, kinetic constants and/or starting concentrations, said method comprising minimising the difference between observed and predicted properties, wherein said predicted properties comprise the concentrations as predicted by the method of predicting concentrations of biological entities according to the present invention. For example, steady-state or equilibrium concentrations of certain biological entities may be amenable to experimental determination. As regards the in silico method of predicting concentrations of biological entities according to the present invention, the predicted steady-state or equilibrium concentrations of these biological entities will depend, to a varying extent, on the values assigned to those parameters which are unknown. By minimising the difference between observed and predicted properties, the unknown parameters are optimized in the sense that the obtained kinetic model is the model which reproduces best those properties the difference of which between experiment and simulation has been minimized. This minimisation may involve continuous optimisation, i.e., minimization of said difference, during performing the method of predicting concentrations of biological entities according to the present invention. The term “optimization” relates to optimization of the above defined parameters, i.e., of, e.g., kinetic constants and/or starting concentrations, such as by using non-linear regression type approaches. Moreover, optimization may, alternatively or in addition, involve discontinuous steps, such as modifications of the topology of the network and/or of kinetic laws. Preferably, the agreement between predicted and experimental values is optimized for all available measurements. Generic computational means and methods for minimizing differences between observed and predicted values or parameters are known in the art. In preferred embodiments, said network topology and/or said kinetic laws are completely known.

The present invention furthermore provides a computer-implemented method of selecting one or more experiments, the method comprising (a) performing a plurality of experiments in silico by performing the method of predicting concentrations of biological entities according to the invention, wherein said performing is done for each experiment repeatedly with different choices of unknown parameters, said parameters being selected from network topology, kinetic laws, kinetic constants and/or starting concentrations; and (b) selecting, out of said plurality of experiments, those one or more experiments for which said method of predicting concentrations of biological entities yields, depending on said different choices, the greatest variance of predicted concentrations.

The term “experiment”, if not specified otherwise, relates to a real-world experiment which is to be performed. It may be an experiment comprising performing a knock-down of one or more genes, the administration of one or more siRNAs (small interfering RNAs) specific for one or more genes, and/or the administration of one or more modulators of the activity of one or more polypeptides such as an enzymes, in or to, respectively, a biological system. Preferably, said biological system is an in vitro system. Preferred modulators are drugs or lead compounds suitable for the development into a drug.

In other words, provided is a computer implemented method to select those experiments, which will most efficiently discriminate between different alternative forms of the model, and will be most effective in determining the unknown parameters by modelling the experiments, with all possible models. Those experiments, for which the difference between the predicted values of properties such as concentrations, which can be experimentally determined, are maximal, will provide most information about which of the different forms of the model are more likely to be correct, and can therefore be selected among a larger set of possible, but maybe less informative, experiments.

In preferred embodiments of the method of selecting one or more experiments, said network topology and/or said kinetic laws are completely known. Preferably, said choices are random choices as detailed further above. In a further preferred embodiment, the selected experiment(s) is/are performed.

The Figures show:

FIG. 1:

Endomesoderm Network Topology reproduced from Davidson et al [14, 4]. The topology is produced using Biotapestry [15].

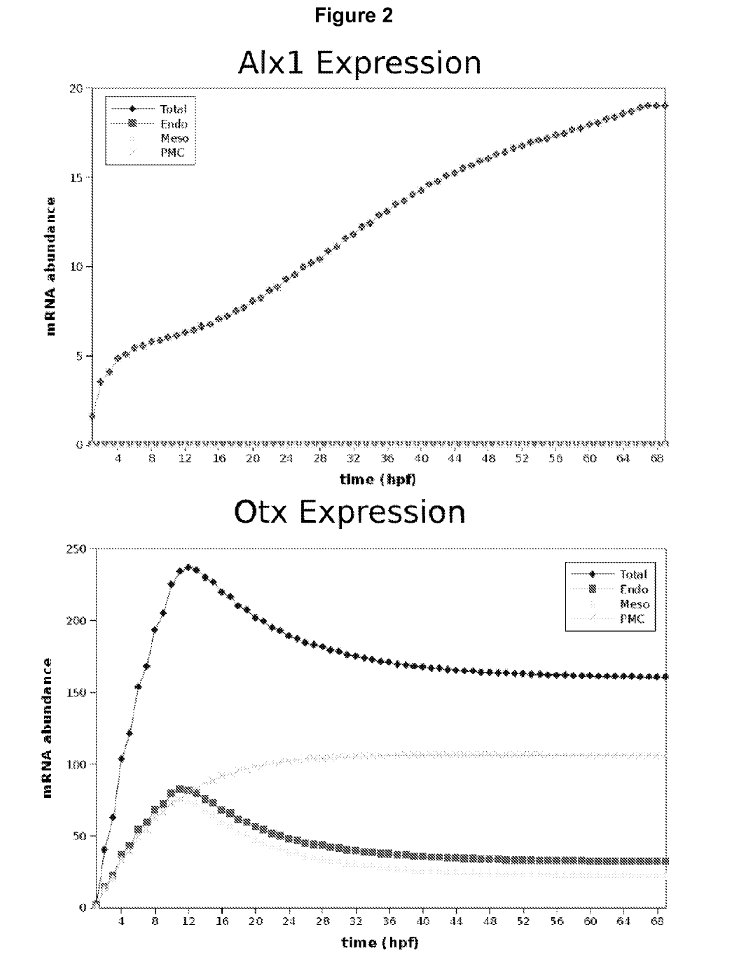

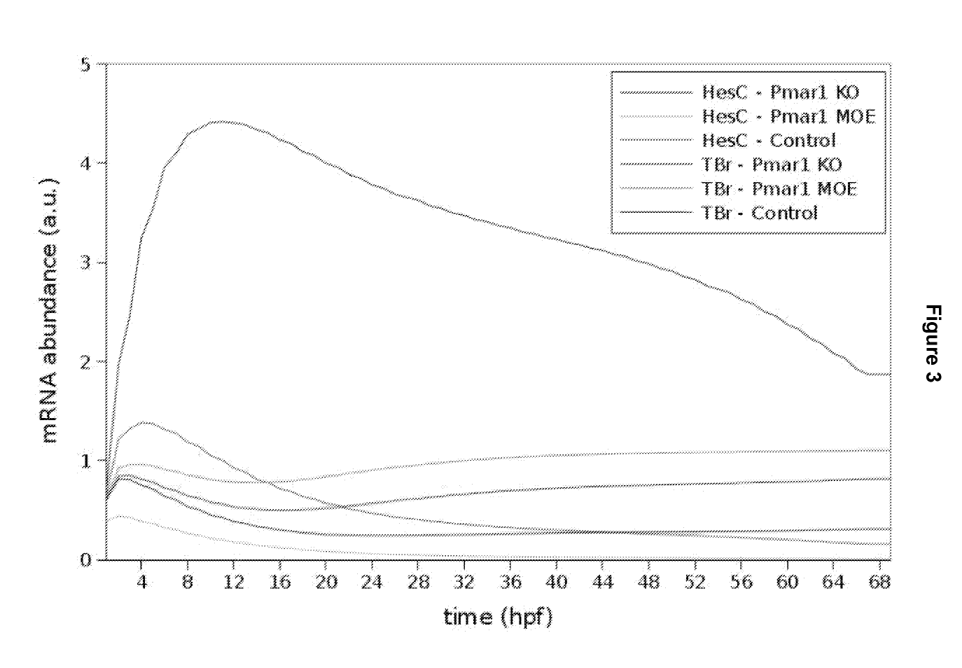

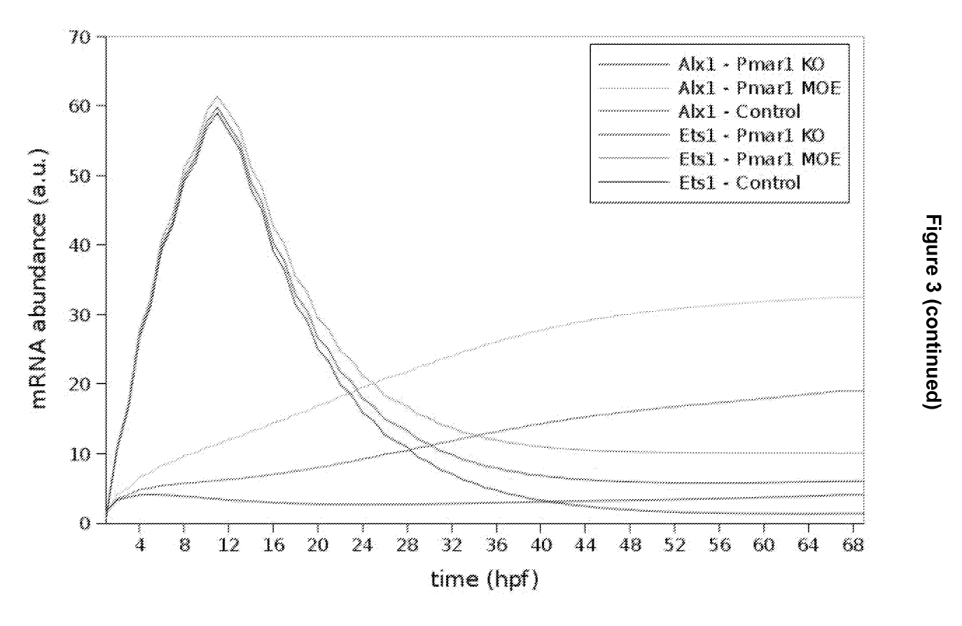

FIG. 2:

Simulated time courses for alx1-mRNA and otx-mRNA. mRNA abundance is given in arbitrary units, time is given in hours post fertilization. The mean of 800 simulation runs is plotted at each time point.

FIG. 3:

Expression of genes affected by perturbations of pmar1 expression. mRNA abundance is given in arbitrary units. Detected perturbation effects are in accordance with experimental data as described in [25].

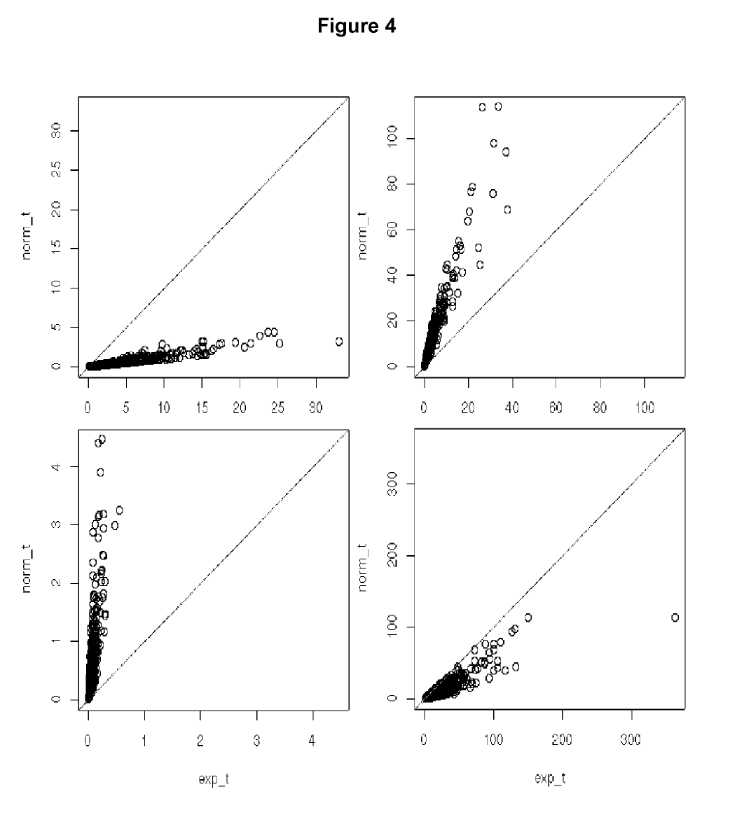

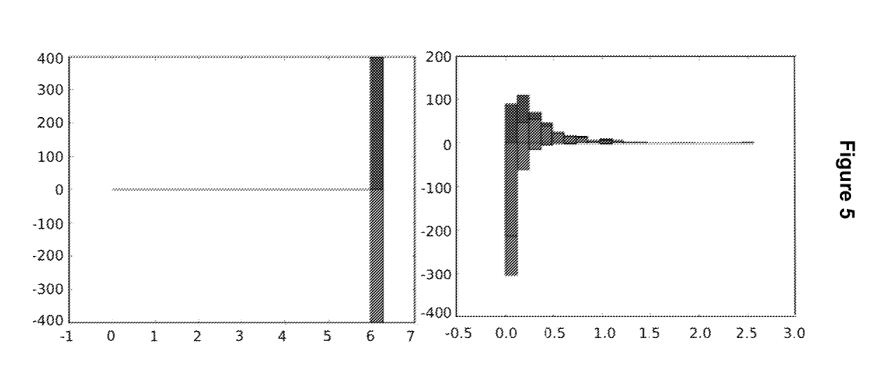

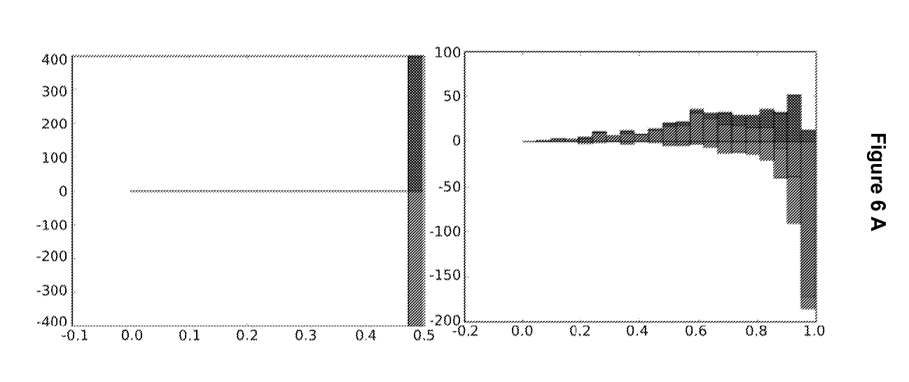

FIG. 4:

Scatterplots comparing the abundance of hesc-mRNA (left) and alx1-mRNA (right) between unperturbed and pmar1-MASO conditions (top) as well as unperturbed and alx1-MOE conditions. The x-axis represents mRNA abundance in perturbation conditions, the y-axis represents mRNA abundance under unperturbed conditions. The abundance is measured in a.u. at time point 25 hour post fertilization (hpf). Values for 800 different parameter sets are plotted. Deviations from the diagonal indicate higher expression in perturbation conditions (below the diagonal) or lower expression in perturbation conditions (above the diagonal).

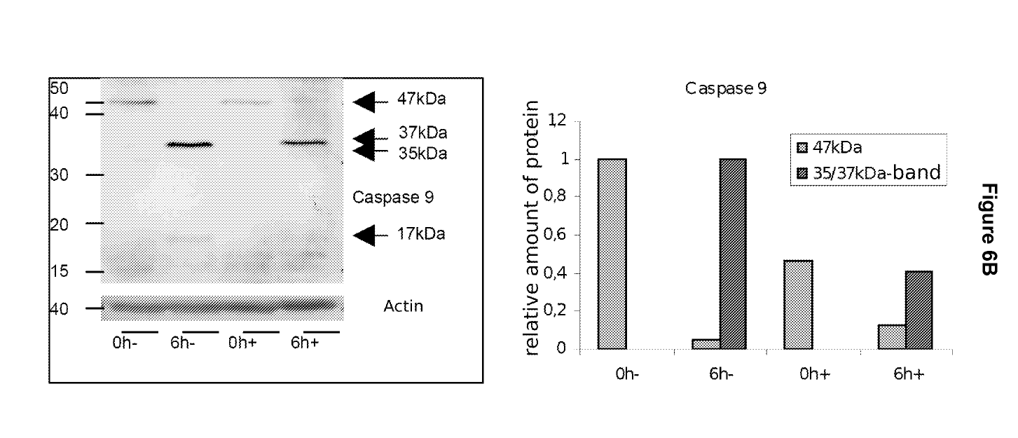

FIG. 5:

Amount of cleaved caspase 9 before (left) and after (right) induction of apoptosis. Green corresponds to 80% caspase 3 knock down, blue to the control, and red the difference between the two. The length of the bars (y-axis) shows the number of Monte-Carlo-simulation with the respective results (x-axis). The initial protein concentrations are randomly chosen and apply for all 400 simulations.

FIG. 6:

Upper panel (A): Amount of caspase 9 (uncleaved) before (left) and after (right) simulated induction of apoptosis. Lower panel (B), left: Western blot of Caspase 9 expression in WI38 cells at 96 hours transfection with Caspase 3 siRNA without (0h+) and with induction of apoptosis by staurosporin (6h+) compared to untransfected cells without (0h−) and with induction of apoptosis (6h−). Lower panel (B), right: quantification of Western blot with AIDA. Values are normalised with actin.

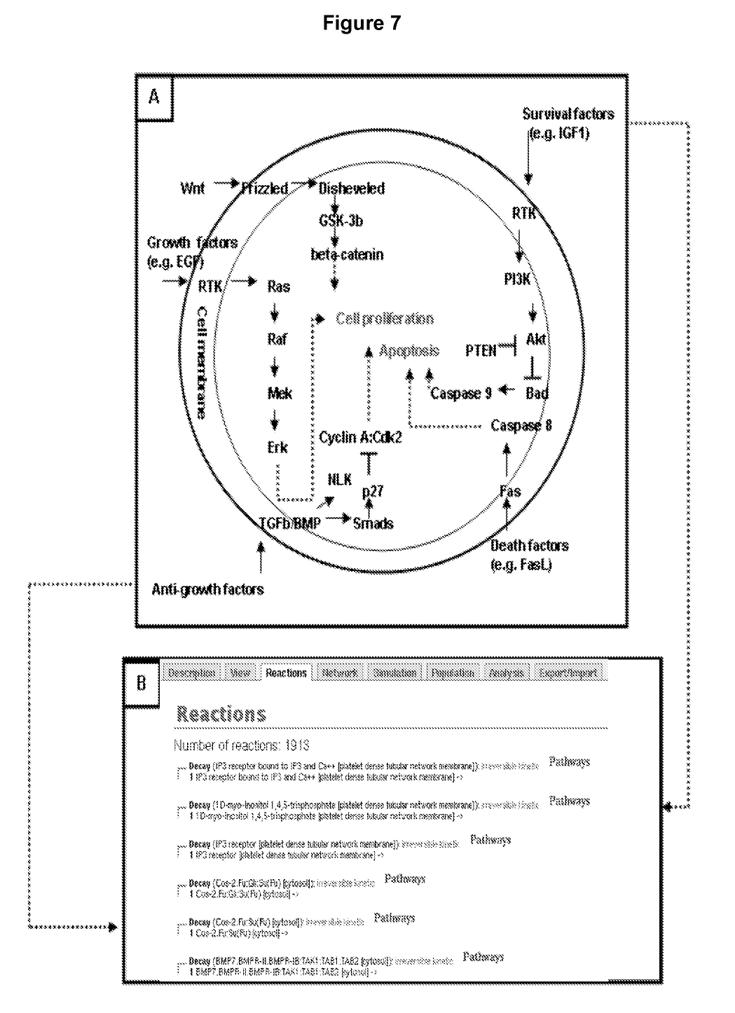

FIG. 7:

Annotation and network model process

(A) Part of the signaling pathways that comprise the minimal network for cancer treatment. (B) Translation of these functional interactions in computer readable reaction systems within the PyBioS system.

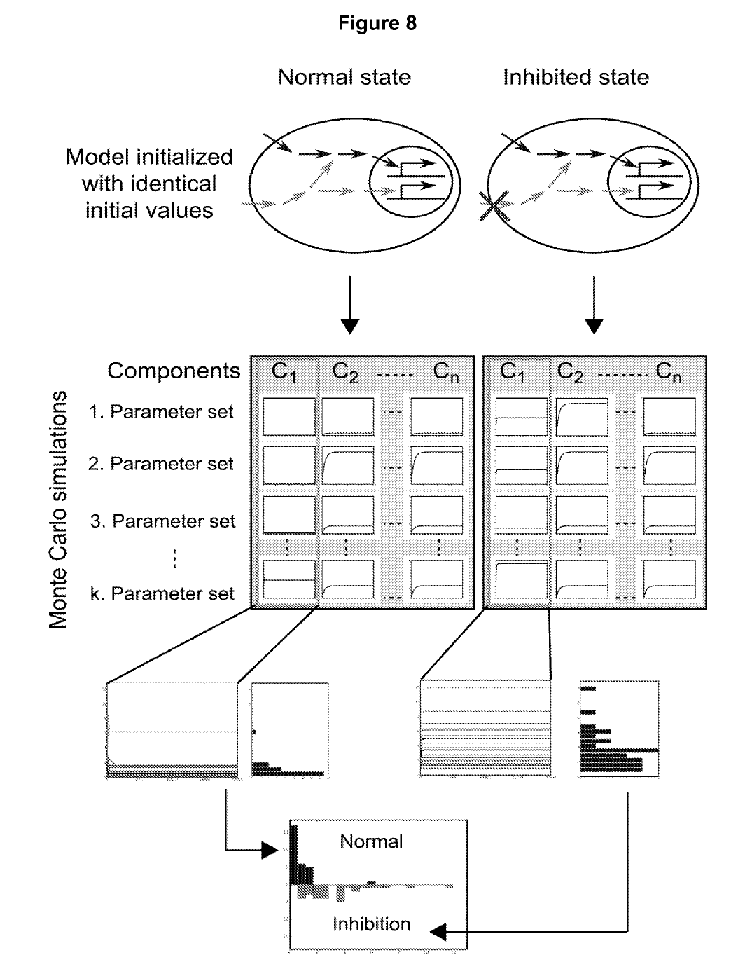

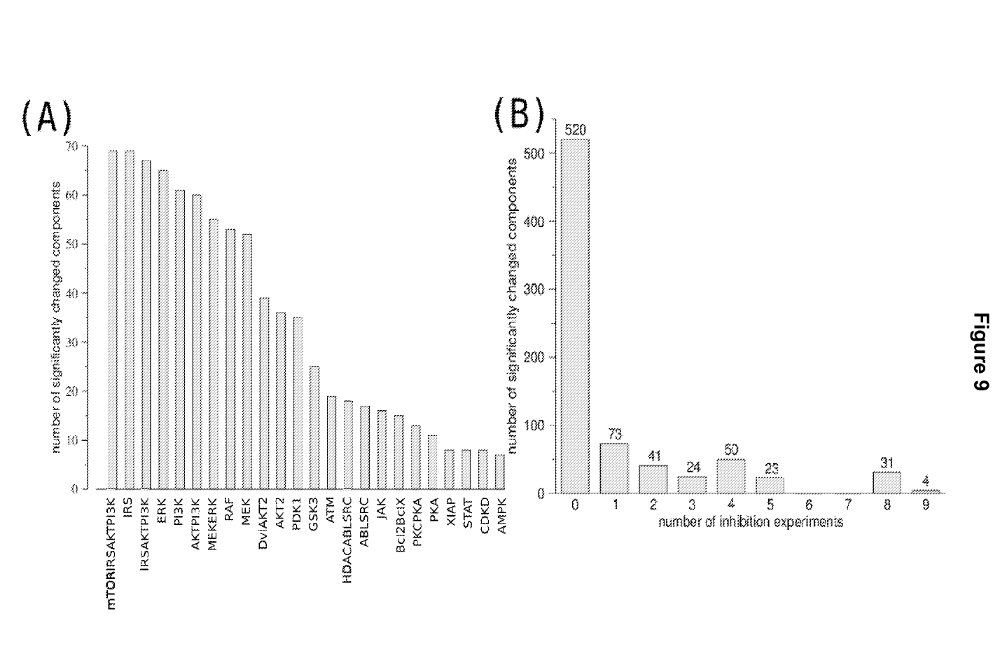

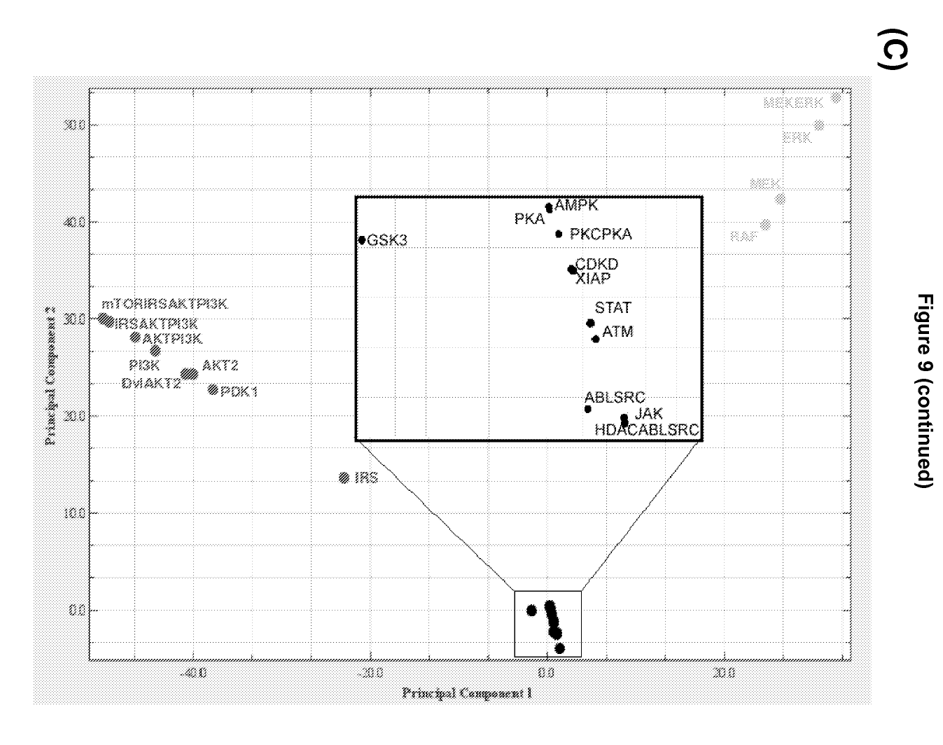

FIG. 8:

Flowchart of the proposed Monte Carlo approach

Steady state simulations are performed for the normal state and the perturbed state (inhibition by a drug). The normal and perturbed states are initialized with the same set of kinetic parameters and initial values for all model components except the inhibited components. Subsequently, the model is simulated into its steady state. This procedure is repeated k times with different parameter vectors, which are sampled from a given random distribution. For graphical examination, steady state results of the respective control and treatment simulation runs are plotted with histograms for every component of the model. Furthermore, the distribution of the results between control and treatment is quantified by a P-value calculated by the Kolmogorov-Smirnov-test for each set of control/treatment values.

FIG. 9:

Global statistics

(A) The number of significantly altered model components for each inhibition experiment describes individual sensitivity of the treatment. (B) The histogram depicts the sensitivity of the model components with respect to the panel of inhibition experiments. It displays the number of model components (Y-axis) that are significantly changed by a given number of the 24 inhibition experiments that are analysed in this study (X-axis). (C) Principal component analysis (PCA) of the log-ratios for the 24 different inhibition experiments. PCA was conducted with J-Express Pro (Molmine, Bergen). The two first principal components (out of 767) explain 67% of total variance.

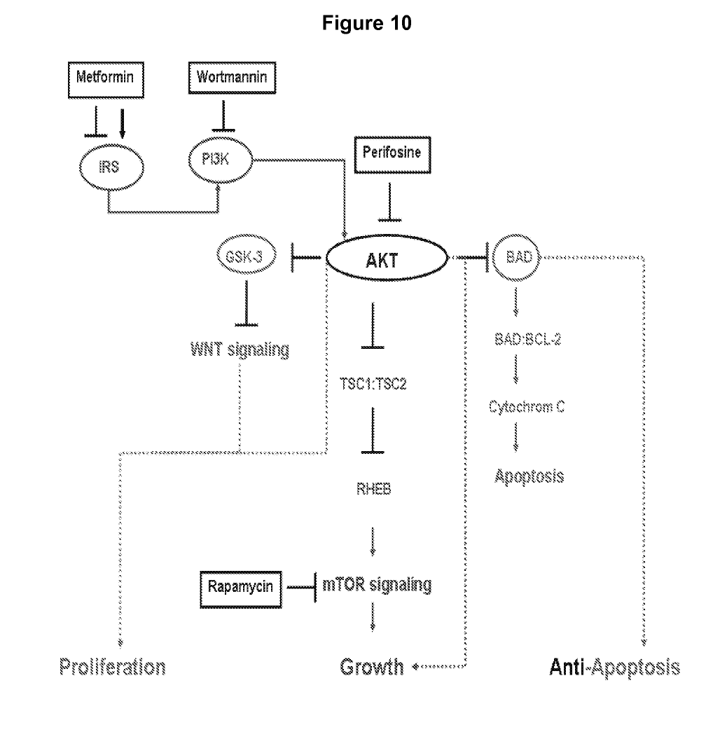

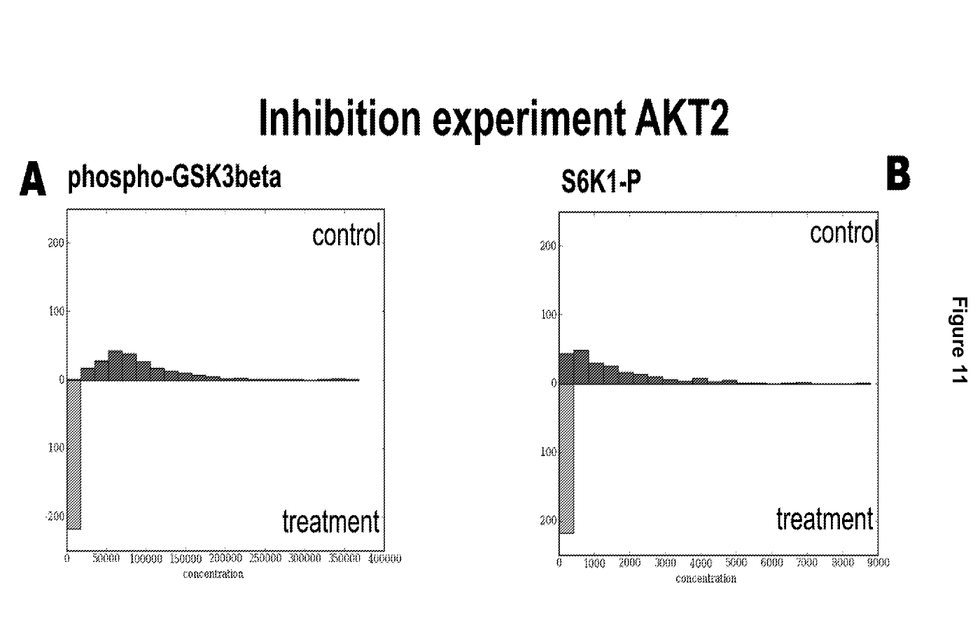

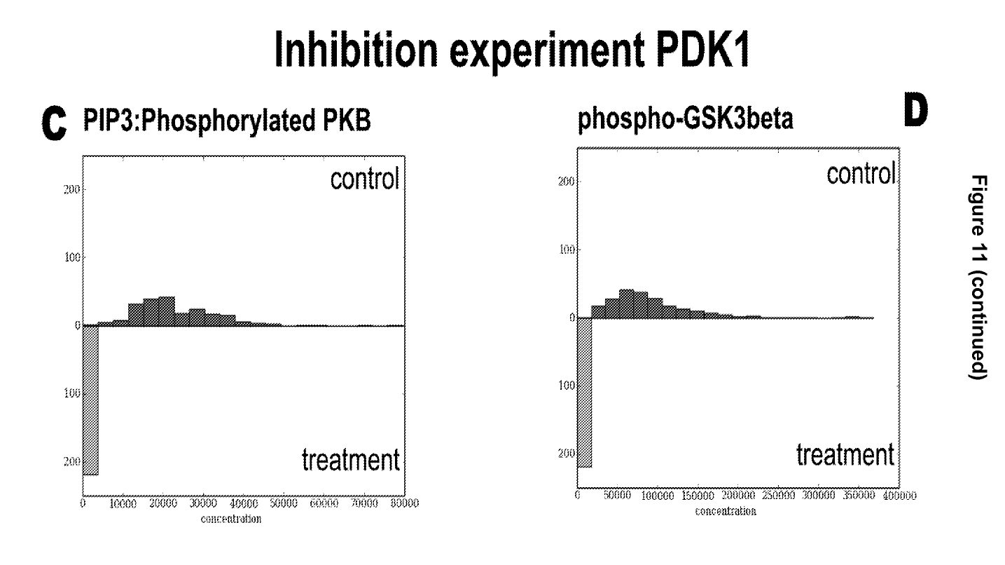

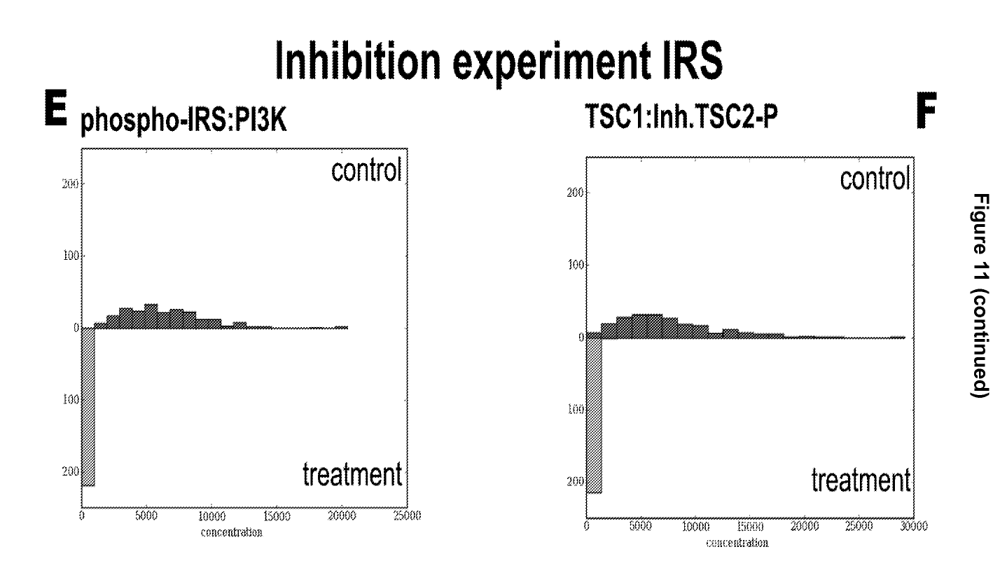

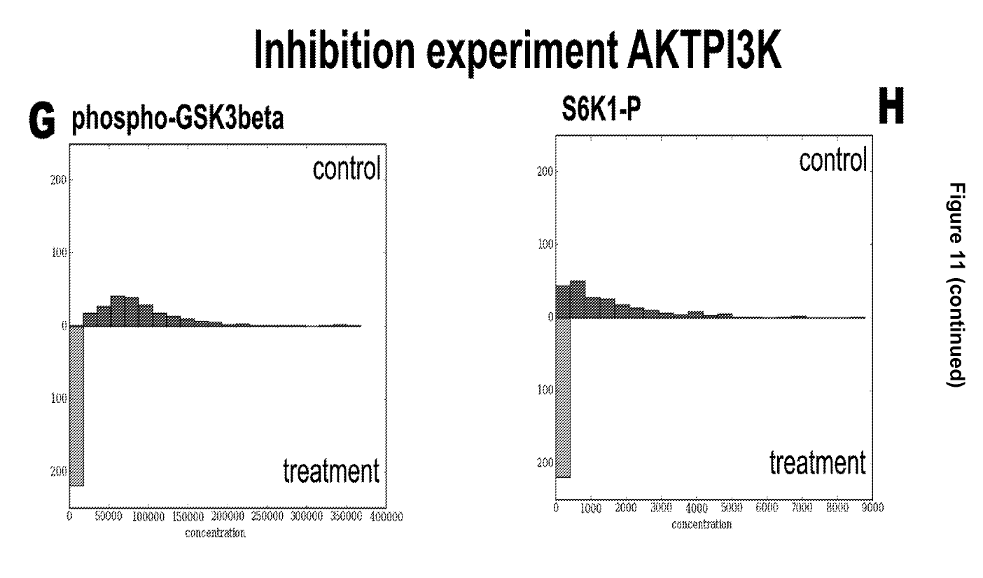

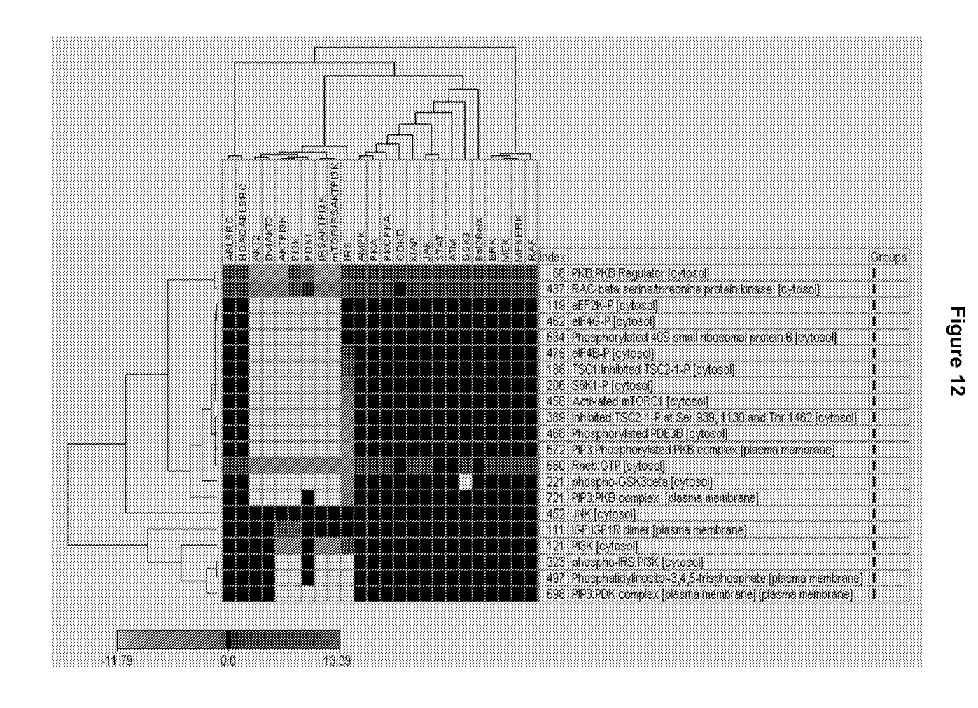

FIG. 10:

Specific inhibition experiments targeting AKT signaling

A scheme depicting four drugs/small-molecule inhibitors (Perifosine, Wortmannin, Metformin, and Rapamycin) that target the composite network regulated by AKT. Changes influence proliferation, growth and apoptosis. Inhibition is indicated by a blunted line. IRS: Insulin receptor substrate, AKT: Protein kinase B, PI3K: Phosphatidylinositol 3-kinase. mTOR, mammalian target of Rapamycin.

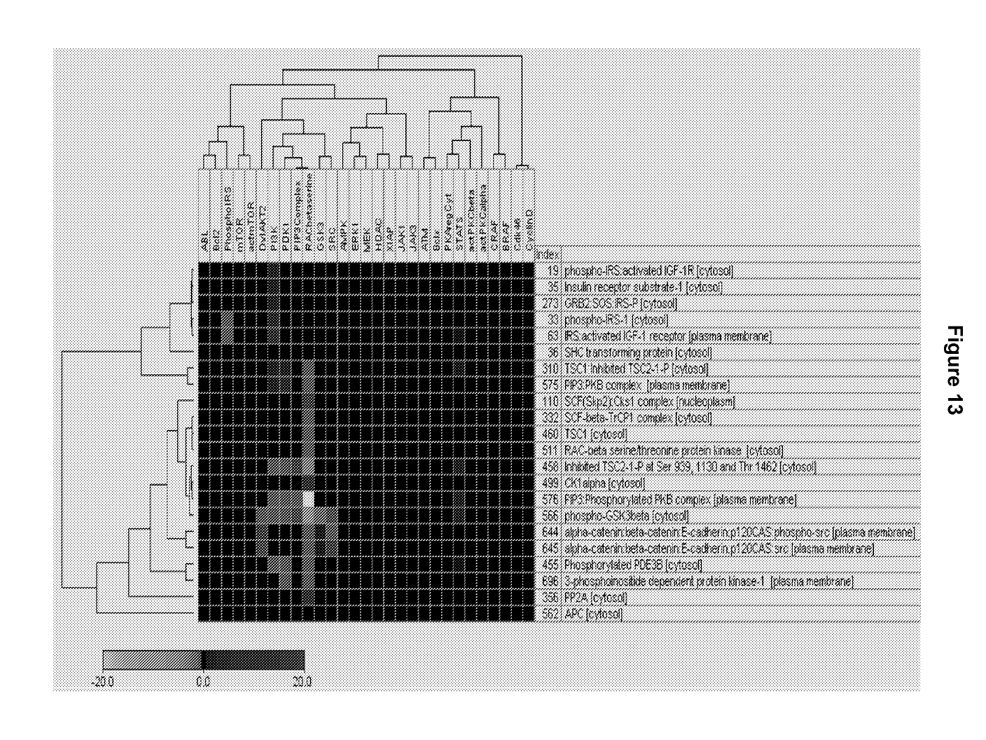

FIG. 11:

Direct and indirect effects of drug target inhibition

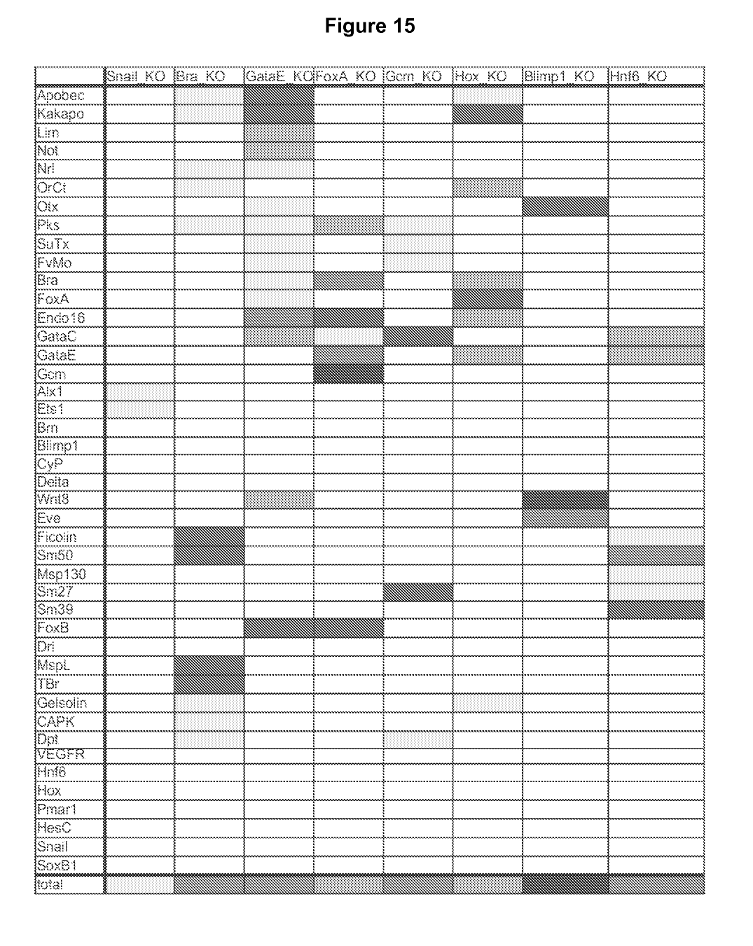

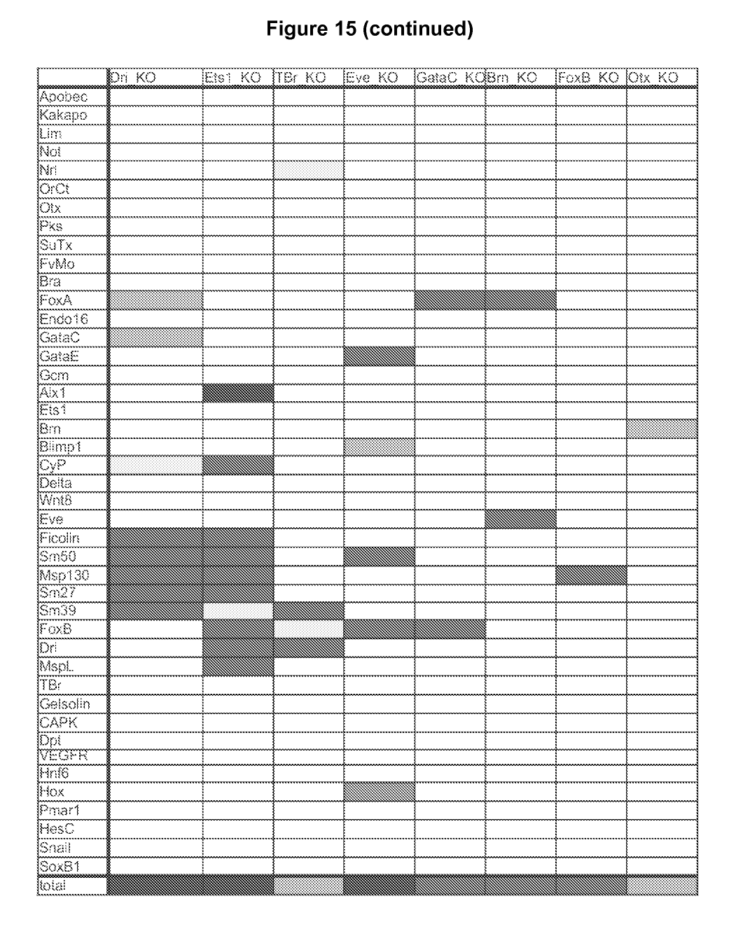

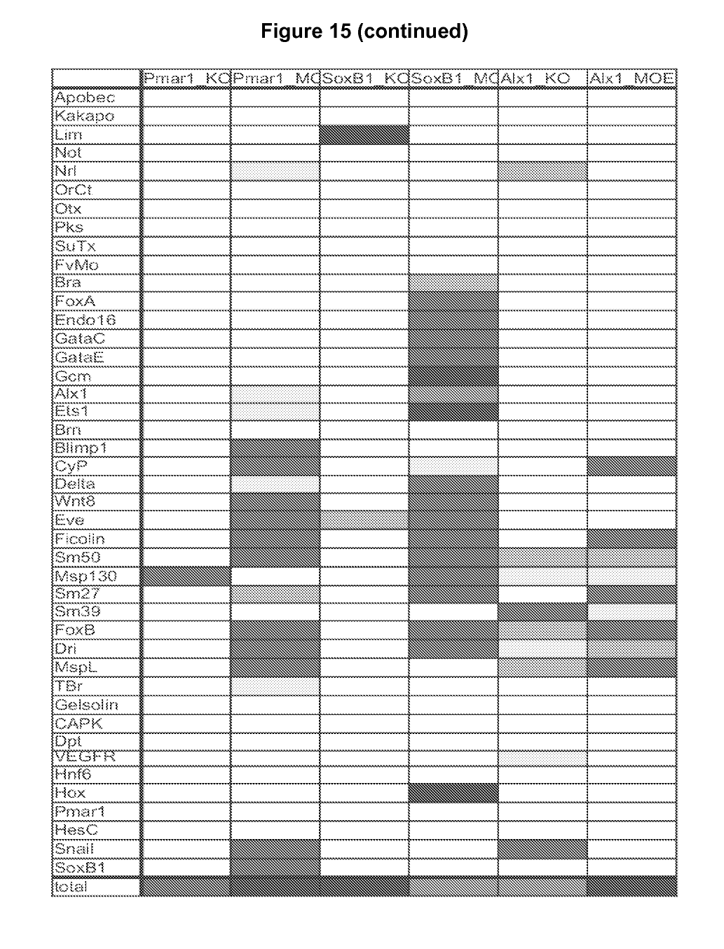

Histograms of the steady state frequency of selected control (upper bars) versus treatment states (lower bars). Selected results show direct (left panel) as well as indirect (right panel) effects of the specific inhibition experiment displayed in FIG. 15. (A) Direct effect of the inhibited AKT2 on the concentration of “phospho-GSK3beta”. (B) Indirect effect of AKT2 inhibition shows inhibition of “S6K phosphorylation”. (C) PDK1 shows a direct effect in the inhibition of “PIP3:Phosphorylated PKB”. In addition, the inhibition of “phospho-GSK3beta” is considered as an indirect effect in the therapy domain (D). (E) IRS exerts a direct effect through the inhibition of PI3K in form of “phospho-IRS:PI3K”. (F) Inhibition of activated IRS results in inhibition of the “TSC2-P” phosphorylation. (G) Therapy domain AKTPI3K shows a direct effect on “phospho-GSK3beta” and an indirect effect (H) on “S6K1-P”. A total of 250 simulation runs has been performed for each inhibition experiment. In practice, a number of simulation runs failed because of runtime restrictions that were exceeded by a certain amount of simulation runs so that the resulting number of simulation runs is lower (220 on average).

FIG. 12:

Co-expression cluster of drug action involving AKT inhibition

Log-ratios (base 2) of average steady state values of the treatment and control states with respect to the different inhibition experiments (columns) and model components (rows). Red color indicates up regulation, green color indicates down regulation of model components with respect to the inhibition. Pearson correlation has been used as pairwise similarity measure and average linkage as update rule. Clustering was performed using J-Express Pro (Molmine, Bergen).

FIG. 13:

Cluster of model components showing high sensitivity with respect to AKT (RACbetaserine).

Cluster of model components showing similar sensitivity patterns across 29 different single-inhibition experiments that were used for this study. Sensitivity values for each drug target (columns) were computed for all model components (rows). Sensitivity values on a scale from −20 to 20 are plotted. High-sensitivity components are red or green, as indicated by the color scale. Clustering was performed using J-Express Pro (Molmine, Bergen). The following examples illustrate the invention but should not be construed as being limiting.

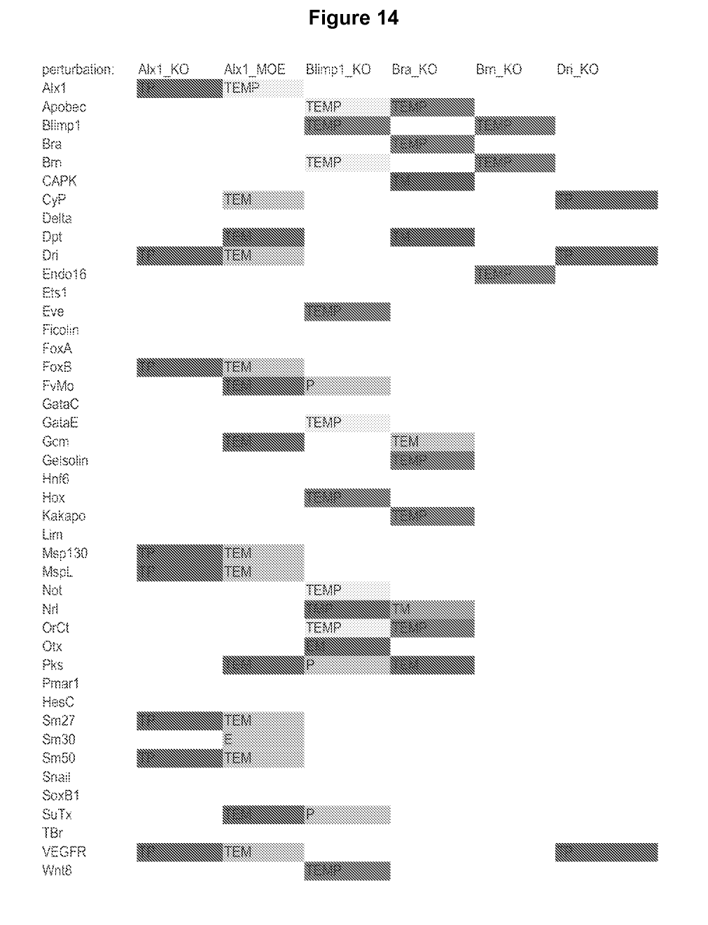

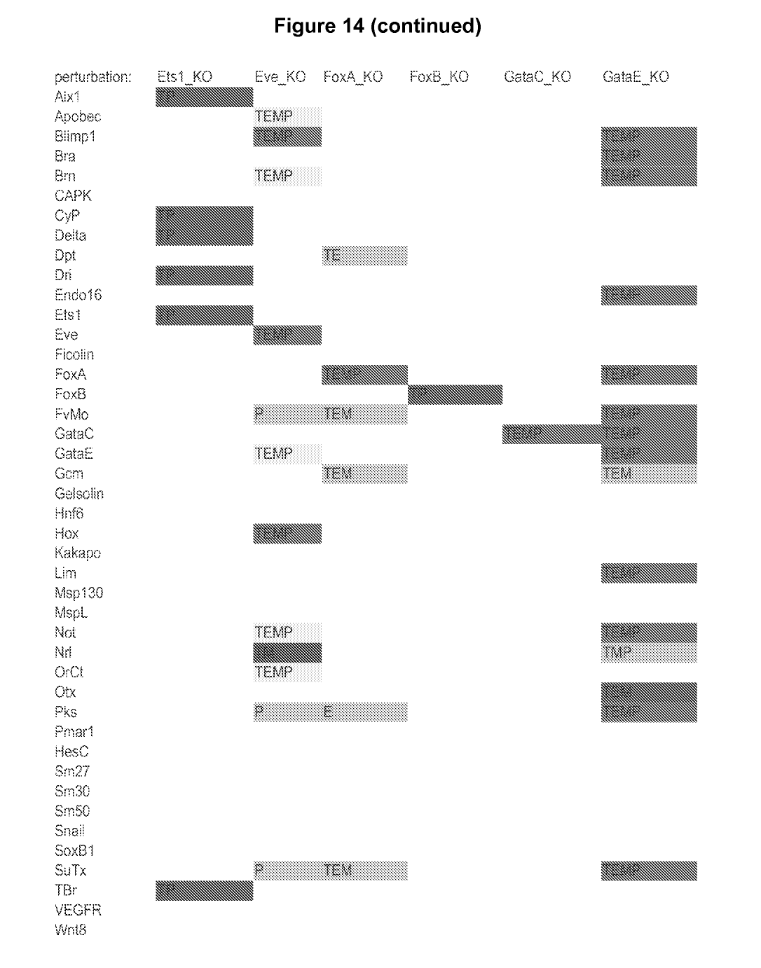

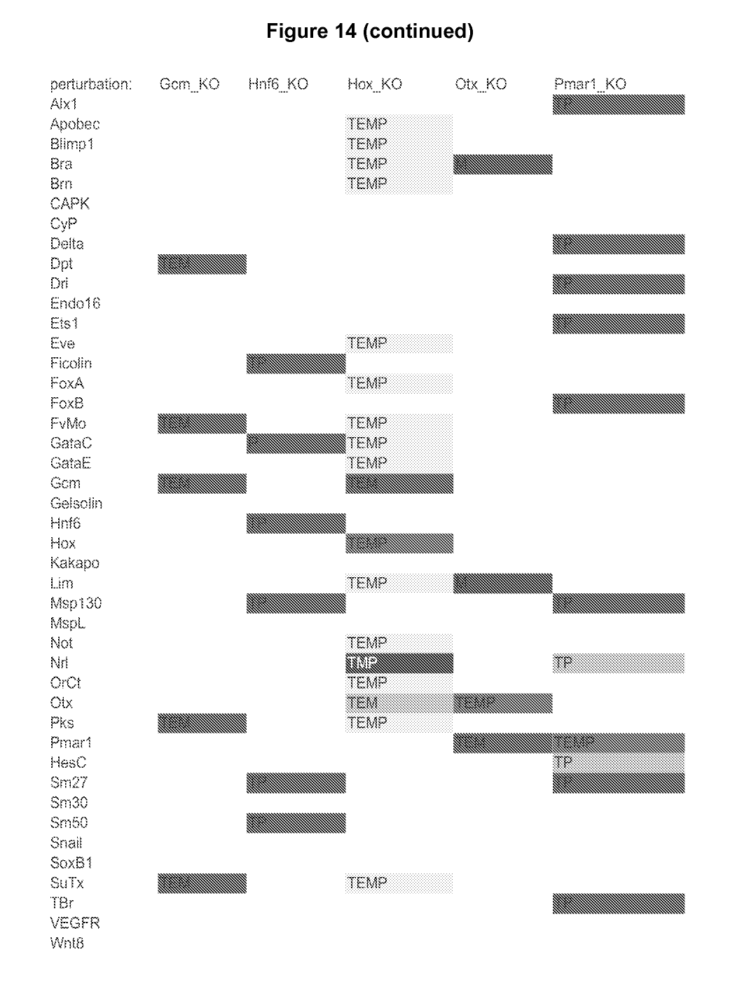

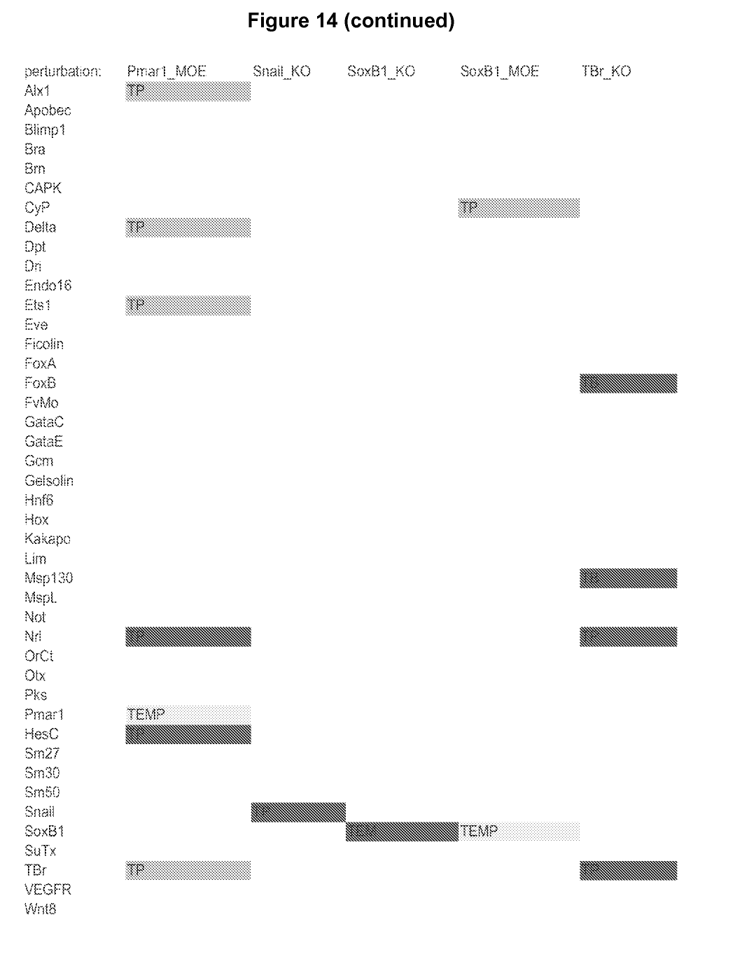

FIG. 14:

Qualitative results of the perturbation simulations.

Green colored cells indicate increased expression of the gene in row due to the perturbation of the column, red indicates reduced expression. Cells are shaded to highlight effects contained to certain territories. The territories affected are mentioned in the individual cells (E: endoderm, M: mesoderm, P:PMC, T: total of all territories). Temporal expression information was excluded in the table, so that if a gene effected at any given time point, the effect is assigned to the gene in general.

FIG. 15:

Qualitative overview of the comparison between simulation and experimental data. To shorten the table, comparison results for different time points have been combined. The coding is as follows: green indicates that all experimental data for the perturbation and effected gene were matched, green and black patterns indicate that there are more matches than mismatches for given perturbation and gene, gray indicates as many matches and mismatches, red and black patterns more mismatches than matches and red exclusively mismatches. The last row indicates the average of each column.

### EXAMPLE 1

### Endomesoderm Network

Background

The development of an adult organism from a fertilized egg is a complex as well as fundamental process. Development includes specification of individual cells driven by signals from surrounding cells as well as cell motility and cleavage events. Although the main regulatory inputs are generated by a multitude of cells, the microscopic events that generate these macroscopic effects must be precisely regulated at the cellular level. Thus, the developmental mechanisms include signaling events and protein interactions as well as gene regulation and cell-cell interactions. Understanding these developmental mechanisms and the differences of these mechanisms in between different species can give insight into evolutionary mechanisms [1]. Furthermore, any perturbations during development are likely to manifest themselves in the organism in some way.

The scientific analysis of development has begun in the 1890s using sea urchins [2]. The sea urchin is not only a model organism for historical reasons but also for its interesting evolutionary position. Fundamental processes of the evolutionary program are expected to have parallels in mammalian development [3].

Today, the most ambitious effort in understanding the development of sea urchins is the Endomesoderm Network in Strongylocentrotus purpuratus (S.pur.) [4]. This network attempts to catch the structure of the complex gene regulatory network (GRN) that controls and regulates the development in the early sea urchin embryo, mainly the specification of endoderm, mesoderm and primary mesenchyme (PMC) territories. The interactions between the genes are inferred from perturbation experiments, mainly morpholino-substituted antisense oligonucleotide (MASO) injection effectively knocking down mRNA translation of a specific gene [5], mRNA overexpression and fusion with an engrailed repressor domain. This network (FIG. 1) is static and one needs to define rules for the type, timing and strengths of interactions. Using the methods of the invention, the Endomesoderm Network has been modeled using ordinary differential equations (ODE). Since experimental data are mainly based on perturbation experiments [4] and detailed studies have only been carried out for a limited number of genes [6, 7, 8, 9, 10, 11, 12, 13], the experimental data are insufficient to fully parametrize the resulting model.

In order to predict the time-dependent behavior in spite of sparse data, we carried out simulations using randomly sampled parameters. In addition to detecting the sensitivity of each network component to parameter variations, effects are detected of perturbations pertaining to the experimental data the network is based on that are robust to parameter variations. This is achieved by simulating the model under normal and perturbed conditions using the same parameter sets. Comparison of the resulting pairs of simulation indicates effects that are independent of the parameter values used.

The comparison results indicate to which extent the model topology is able to reproduce the experimental data. One cannot prima facie expect that all interactions within the network are invariant to parameter changes.

Validation is done using randomized versions of the model. The same analysis as carried out with the original model is applied to randomized versions of the model. By comparing the extent to which the original model reproduces the experimental data with the extent the randomized versions reproduce the data, the validity of the original model is inferred.

Methods

Inference of Network Validity

To infer the validity of the network topology, the input file containing the network structure was converted to an ODE model in PyBioS [29, 30]. The resulting model is formulated in Python [31] and can readily be simulated.

To create more realistic simulations of the different embryonic territories in question, a model was created that contains three copies of the same original model which are all independent form each other. Since we apply different external inputs to the system, we can discriminate the different territories by these inputs. Using the PyBioS output, sets of random parameters for the transcriptional regulation are sampled for simulation of the model. The model was simulated over 70 time steps, where one time step corresponds to one hour post fertilization (hpf). Since externally set inputs are used to discriminate the embryonic territories, these inputs serve as timers, establishing timeframes of expression according to experimental data.

To model knockdown experiments, the model in PyBioS syntax was changed by setting the rate law for the mRNA production in question, from ν_{transcription} to ν_{transcription}·0.05. For overexpression experiments, ν_{transcription} was changed to ν_{transcription}+2 since the maximal expression rate reached in the original model is about 2/h in arbitrary units. Using randomly sampled parameter values, this value becomes arbitrary and might be a source of errors in the analysis of MOE experiments.

Any number of models altered in the way described above and the original model can be simulated using the same parameter sets. The parameter sets used in this study were sampled from a lognormal distribution with σ=1.5, μ=0.5. This is a preferred distribution according to the invention. This distribution was in part chosen to avoid too extreme parameter values that could impede the numerical stability of the ODE system. In this study, we used 800 different parameter sets for simulation.

The next steps are computed for each set of simulation results for one specific perturbation p for each of the possibly effected genes X under all possible parameter sets S:

A list of time points T is defined, reflecting the time intervals given in [19] so that T=(14, 19, 25, 33, 45, 66).

The results for all parameter sets S under condition p and unperturbed condition C are aligned in pairs:

For each tεT, the closest simulation time point is determined and the simulation results for both conditions as well as the ratio r_{x,s,t}=[x]_{C,s.t}/[x]_{p,s,t} for each parameter set sεS is stored. These values are used to compute the means r_{x,S,t} and variances var_{x,S,t} over all parameter sets S for each perturbation and gene. This has been computed for all three territories as well as for the sum of the three territories.

The values for one gene x are shown in a scatter plot in FIG. 15 for visual orientation. The effect of a perturbation is measured as the number of expression ratios above or below a certain threshold. Specifically, we enumerate the ratios that are above a certain threshold zᵤ or below a certain threshold z₁.

If, for one given time point t, r_{x,s,t}>zᵤ with zᵤ≧1 for more than T of S_{R}, then gene x is said to be significantly downregulated by perturbation p at time point t. If, on the other hand, r_{x,s,t}<z₁ with z₁≦1 for more than T of S_{R} and one specific t, x is said to be significantly upregulated under perturbation p at time point t. In this analysis, we set zᵤ=z₁=1 and threshold T=90%. In order to discriminate from insignificant changes, we considered any effect for which 0.8≦r_{x,s,t}≧1.25 for T of S_{R} to be insignificant. Using all simulation results for all the perturbations computed and comparing them with the available experimental data, i.e. it is possible to compute to which extend the model reproduces the experimental data, the validity of the model, as the fraction of upregulations/downregulations/indifferences in the simulation results that match experimental results. To infer the overall validity from the independent simulations of the different territories, we have chosen to count a match with experimental data in at least one of the territories as a significant match between model and experimental data.

The extent to which a set of simulations reproduces a given set of experimental data depends on the choices of zᵤ, z₁, T and the thresholds for insignificant effects. Due to the limited knowledge of the system, we set chose relatively loose thresholds. When the model is of smaller size or subsets for which detailed and comprehensive models are available are used, one might choose to tighten these thresholds.

Inference of Robustness

The inference of robustness of different components of the Endomesoderm Network model uses only simulation results of the unperturbed model. By comparing the simulation results from all available parameter sets, the extent to which the simulations results for each gene differ depending on parameter values is extracted. The extent of these variations is the robustness of the genes' expression to parameter values.

It is assumed that there exists one true time course of a gene's expression, which is not necessarily found by the sampled parameter sets. Nevertheless, it is further assumed that the simulation results for the different parameter sets are normally distributed around the true time course when analyzing individual time points of the time course.

This assumption permits to compute the mean μ and variance σ² of the mRNA concentration for each gene at different time points. To measure the extent of the variance with respect to the mean, we compute the relative variation varᵣₑₗ=which can be compared in

$$\frac{{σ}^{2}}{μ}$$

between time points ma genes independent of absolute mean or variance values. It basically provides a variance relative to the corresponding mean.

When choosing a sufficient number of time points for each gene, the list of varᵣₑₗ can be used to obtain the general robustness of the gene's expression, here done by choosing the maximal varᵣₑₗ for each gene. The resulting values might differ substantially, indicating different levels of robustness. varᵣₑₗs and their means are not interpreted as absolute values that determine a cutoff for robust and vulnerable genes since these cutoffs would heavily depend on the realistic parameter values which are unknown.

Randomization of Networks

The ODE model in PyBioS format. This is, for the threefold model, done by choosing two genes at random and exchanging two randomly chosen inputs to these genes for each territory. We created two random networks repeating this randomization procedure 3000 times and one model repeating the randomization step 30000 times. Note that the borders between the three territories are maintained. Using this randomization algorithm, general features of the network like the number of nodes and edges, the average node degree and the degree distribution are preserved while the individual wirings are changed. After a randomized network has been constructed, its validity can be determined as described above. In this analysis, we constructed 2 randomized models using 3000 randomization steps and simulated each using 100 different parameter sets. To infer the effect of stronger randomization, we also constructed one model using 30000 randomization steps and simulated it using 20 parameter sets.

Results and Discussion

Dynamic model of the Endomesoderm Network

The Endomesoderm Network [4] depicts the presumed regulatory interactions between genes that drive the differentiation of endoderm, mesoderm and PMC in the sea urchin S.pur. Refined versions of this network are available [14] as well as the underlying data [19]. Additionally to this data, the regulatory interactions of some genes have been studied in detail [6, 7, 8, 9, 10, 11, 12, 13].

Perturbation as well as available time course data is—in the mentioned sources—generally measured for the whole embryo, although qualitative data is available showing that certain genes are expressed in certain territories only or even follow complex spatiotemporal expression patterns [7, 6, 20]. This differential expression is driven and enforced by direct and indirect interactions between the cells of the embryo [21, 22].

Although each territory differs concerning the expression of genes, abundance of TFs and signaling molecules, we assume that each cell contains the same genetical information, i.e. that no histone modification occurs in the early stages of development. Furthermore, we assume that each territory consists of a homogeneous number of cells, i.e. that cells in the same territory contain the same combinations of TFs and express the same genes.

These assumptions enable us to model each territory (endoderm, mesoderm and PMC) by modeling just one cell. Thus, we construct a model that contains three duplicates of the same mechanisms. Differential expression between the modeled cells can thus solely arise from differences in intercellular signaling and different starting conditions. Since the endoderm, mesoderm and PMC do not constitute the entire embryo and the exact mechanisms of intercellular signaling as well as diffusion rates in the embryo are unknown, we decided to exclude these mechanisms. In order to include the effects of these different signaling events in spite of excluding the underlying mechanisms, we used the data contained in [19] to mimic the temporal input to each territory that is not emerging from the model itself. Given these appropriate initial conditions and artificial inputs mimicking extracellular processes, the model should be capable of reproducing the behavior of endoderm, mesoderm and PMC cells.

When applying a perturbation in the form of a knockdown (KD) or overexpression of a single gene to this system, the effect on each single territory can be determined. Since we do not know the exact composition of the embryo at a given time point in order to combine the effects to a total effect as measured in the experimental data, we suggest that detection of the effect of a perturbation in at least one of the territories indicates an according behavior of the entire embryo. Using this model, we can therefor test the existing topology while it also facilitates integration of new experimental data and testing of alternative hypothesis in a formal way.

Models of ordinary differential equations (ODEs) are widely used in such applications. They enable analysis of steady states as well as the detailed simulation of time courses [23]. Since they produce more detailed results than simpler modeling frameworks, models of ODEs also require more detailed information about the modeled system.

Using the kinetic laws described herein above, we constructed an ODE model using the topology of the Endomesoderm Network, see FIG. 1. This model consists of 54 genes and 140 variable species altogether for each cell type. Including transcription, translation, degradation of mRNA and proteins and complex association and dissociation, the model comprises a total of 278 reactions controlled by 287 parameters (translation, mRNA degradation and protein degradation are controlled by one ubiquitous parameter) for each cell type. These numbers illustrate again why parameter estimation is currently infeasible for this network.

FIG. 2 shows simulated time courses for different genes and territories. These time courses might not reproduce experimental time courses, but this was never the goal of this analysis and would indeed require parameter estimation. Nevertheless, these time courses demonstrate that our model is capable of producing differential expression. The time course for alx1-mRNA abundance clearly shows that it is only expressed under PMC conditions while otx is expressed in all three territories but to different extents in each territory.

Evaluation of the Method

The method described here was tested on a submodel of the Endomesoderm Network consisting of 12 genes [24], which was slightly modified and for which parameters have been estimated to reproduce known time course data, not the perturbation data. Assuming that the estimated parameters are the true parameters and the dynamic behavior of the network is correct, it can be used as a benchmark for the application of randomly sampled parameters to extract topological features of a network.

For this subnetwork, simulated perturbation effects obtained with the estimated parameters were compared to simulated perturbation effects obtained from simulations with randomly sampled parameters. The effects achieved by simulating the model with estimated parameters were used as the reference instead of true experimental data.

The analysis of this subnetwork indicates an acceptable accuracy for the detection of perturbation effects using a model with randomly sampled parameters: 73.8% of the perturbation effects were equally detected in both settings. False negatives (effects detected in using estimated parameters and not detected using sampled parameter sets) constitute 8.1%, false positives constitute 15.7% and 2.1% indicate effects detected with opposite signs in the two settings.

This indicates that using sampled parameter sets to infer topological features of an ODE model yields satisfying results at least for small networks. Since the computation time needed for a great number of simulations depends on a number of factors including network topology and kinetics chosen, an exact comparison between using estimated parameters and sampled parameters cannot be achieved based on this single comparison. Nevertheless, parameter estimation can be infeasible for a system which can be efficiently simulated using sampled parameters depending on parameter interactions and available data.

Robustness of Gene Expression Against Random Parameter Variations

As explained in detail in section Methods, the robustness of a gene's expression is measured by comparing the mean of the expression using different parameter sets at various time points with the corresponding variation by computing the relative variation (varᵣₑₗ=σ²/μ). We have computed the varᵣₑₗ for each gene in the model using 800 parameter sets under unperturbed conditions. For each gene, the highest varᵣₑₗ (pertaining to the lowest robustness) of all time points is used as an indicator of the genes robustness. Generally, the robustness is higher at earlier measurement points. This is due to variations in expression of genes upstream of the analyzed gene that takes time to reach and effect the gene in question.

Table 1 gives an overview over the varᵣₑₗ of each gene in the network. The varᵣₑₗs range from 0.21 to 25.69 for the 800 parameter sets used, indicating that the genes in the network, as it is, differ substantially in their robustness against random parameter changes.

TABLE 1
Overview of the robustness of the different
genes, sorted by robustness.

| Gene | rel. var. | indeg | outdeg |
|---|---|---|---|
| mRNA_SmdBl_70 | 0.211 | 3 | 1 |
| mRNA_GataC_35 | 0.291 | 4 | 1 |
| mRNA_FandB_35 | 0.404 | 3 | 5 |
| mRNA_TBr_35 | 0.490 | 6 | 2 |
| mRNA_FaxA_35 | 0.695 | 7 | 4 |
| mRNA_Blimpl_35 | 0.698 | 3 | 2 |
| mRNA_Eve_7 | 0.810 | 2 | 0 |
| mRNA_Apobec_7 | 0.864 | 2 | 0 |
| mRNA_OrCt_7 | 0.994 | 3 | 4 |
| mRNA_GataE_35 | 1.116 | 2 | 5 |
| mRNA_HesC_7 | 1.187 | 4 | 7 |
| mRNA_Otx_56 | 1.282 | 7 | 1 |
| mRNA_Nrl_35 | 2.153 | 1 | 3 |
| mRNA_Brn_70 | 2.388 | 1 | 0 |
| mRNA_Not_70 | 2.399 | 1 | 4 |
| mRNA_Hnf6_45.5 | 2.443 | 8 | 0 |
| mRNA_Sm50_70 | 2.490 | 8 | 0 |
| mRNA_Mspl30_70 | 2.586 | 2 | 0 |
| mRNA_Lim_70 | 2.586 | 1 | 0 |
| mRNA_CAPK_70 | 2.595 | 1 | 0 |
| mRNA_Sm30_70 | 2.599 | 7 | 0 |
| mRNA_Sm27_70 | 2.632 | 5 | 0 |
| mRNA_MspL_52.5 | 2.685 | 4 | 0 |
| mRNA_VEGFR_70 | 2.737 | 4 | 1 |
| mRNA_Ficolin_70 | 2.759 | 3 | 0 |
| mRNA_Pks_70 | 2.778 | 2 | 0 |
| mRNA_SuTx_70 | 2.797 | 2 | 0 |
| mRNA_FvMo_70 | 2.867 | 2 | 0 |
| mRNA_Dpt_70 | 2.927 | 2 | 0 |
| mRNA_Snail_70 | 2.945 | 1 | 1 |
| mRNA_Dri_70 | 2.990 | 2 | 6 |
| mRNA_Fndo16_70 | 2.992 | 2 | 0 |
| mRNA_Kalcapo_70 | 3.773 | 1 | 0 |
| mRNA_Gelsolin_70 | 3.904 | 1 | 0 |
| mRNA_Gorn_70 | 5.205 | 7 | 7 |
| mRNA_Wnt8_70 | 5.245 | 3 | 1 |
| mRNA_Etsl_70 | 5.440 | 2 | 13 |
| mRNA_Pmarl_70 | 7.090 | 2 | 1 |
| mRNA_Bra_28 | 7.847 | 3 | 9 |
| mRNA_Hax_31.5 | 9.613 | 4 | 4 |
| mRNA_CyP_45.5 | 10.276 | 2 | 0 |
| mRNA_Delta_63 | 10.733 | 3 | 1 |
| mRNA_Abcl_70 | 25.696 | 5 | 7 |

The score associated with the robustness of each gene is the relative variation (varᵣₑₗ) as described in Methods. Results from 800 different parameter sets are used. No clustering or grouping has been applied to this table other than sorting for smallest score (indicating highest robustness). The third column gives the in-degree of the gene (number of incoming interactions), the fourth column indicates the node out-degree (number of regulatory interactions the gene has).

We could not detect a correlation between node in degree and robustness (which would indicate that the robustness of expression increases with increased regulators) nor could we detect a correlation between node out-degree and robustness (which would indicate that important regulatory genes are more robust than other genes). We could also not find a correlation between a gene's position in the network (early endomeso, early PMC, late endo and meso, late PMC) and it's robustness.

This either indicates that the current architecture does not favor any specific set of genes in their robustness against random perturbations or that the network is too small to detect sets of genes that are expressed with similar robustness.

Simulation of Different Perturbations

To be able to infer the validity of the Endomesoderm Network, we needed to simulate different perturbation experiments. To create models of knockdown and over expression (OE) experiments efficiently, we changed the rate laws for transcription, say ν_{transcription} either to ν_{transcription}·0.05 in case of a knockdown or to ν_{transcription}+2 in the case of overexpression.

We did not simulate the effects resulting from the fusion of genes with the engrailed repressor domain since this would require careful adjustments of every affected rate law.

We simulated both the original and the perturbed models using 1000 parameter sets. Due to numerical issues arising from the sampled parameter sets that created very stiff ODEs, only 801 simulation runs finished.

Exemplary, we present the effects of pmar1 perturbations on several genes, like alx1, ets1, tbr and hesc. The means of the mRNA abundance under different perturbation conditions is plotted as time course FIG. 3. Another way to visualize the effects is given on FIG. 4. Here, the abundance under unperturbed and perturbed conditions for one mRNA at a certain time point are plotted for all parameter sets. The visible effects are in accordance with findings described in [25], showing an inhibitory role of Pmar1 on hesc expression and indicating the inhibitory role of HesC on alx1, ets1 and tbr. Our data furthermore shows that if this inhibition is removed, alx1 and ets1 as well as tbr are expressed at a higher rate according to the model.

Visualizations of all simulated perturbation experiments are given in FIG. 14. The results can either be analyzed by perturbation, indicating targets of the perturbed gene, or by effected genes, indicating the regulators of a gene. Columnwise analysis clearly identifies groups of coregulated genes that are indeed associated with different embryonic territories. The knockdowns of alx1, dri, ets1, hnf6 and pmar1 for example have detectable effects under PMC conditions only. Rows with coinciding patterns of regulatory effects indicate groups of genes associated with similar territories/regulators. The group of spicular matrix genes from the lower left part of FIG. 1 differs considerably from the group of secondary mesenchyme cells genes in the lower right part considering their sensitivity to perturbation of different genes. GataE and Hox generally have opposite effects, which can be explained by the inhibitory role Hox has on gatae expression. Comparing the vast effects of hox-KD with its relatively limited role in the network topology, it is obvious that a large number of the detected effects is due to the inhibition of gatae expression. Although obvious from the network topology, this would be rather difficult to discriminate from the simulation results alone. Considering simulation results alone, Hox and GataE might be mistaken as both regulating all effected genes in parallel.

Validity of the Endomesoderm Network Topology

The validity of the Endomesoderm Network (FIG. 1) is evaluated concerning the ratio of experimental results which are reproduced correctly in the simulation results. As the results of the computational analysis yield only qualitative results, the experimental data needed to be translated from quantitative to qualitative data. Some of the existing experimental data was omitted since the data is ambiguous. For example, the expression of foxb in response to gatae-MASO reads as follows: −2.8/−2.4/−3.4, −2.4/NS, +3.7 (where slashes indicate measurements from different experiments, commas indicate replicate measurements and NS indicates values considered insignificant) [19]. Thus, the validity is computed using only unambiguous experimental results. Using a model of the original Endomesoderm Network and models pertaining to MASO and overexpression experiments indicated in [19], the expression of genes in the original and perturbed models is compared. Since our model contains endoderm-, mesoderm- and PMC-specific concentrations and the exact composition of the embryo is unknown, we consider a match between experimental data and any of the simulation results to indicate a reproduced perturbation.

We tested the number of parameter sets necessary for the reliable computation of accordance with experimental data. Since the model contains a great number of parameters, the parameter space containing all possible parameter sets is enormous. Surprisingly, even as little as 20 parameter sets were sufficient to produce results similar to those obtained with 800 parameter sets. These findings, summarized in Table 3, hint towards topological, i.e. parameter invariant, features of the network detected in our analysis.

An overview over the quantitative results of comparison with experimental data is given in Table 2, a qualitative overview is given in FIG. 15. The effects of some perturbations are reproduced very good (gatae-KD, alx1-KD and bra-KD).

TABLE 2
Summary of the comparison between simulation results and
experimental data for the different perturbation experiments.
The number of matches between experimental data and
simulation results are given in column one and the number of
matches as fraction of the total possible matches is given in the
second column. At the bottom of the table, an average is given
for all perturbations.

| Perturbation | absolute | possible | relative |
|---|---|---|---|
| Snail_KD | 2 | 2 | 1 |
| GataE_KD | 19 | 28 | 0.67857 |
| Bra_KD | 8 | 12 | 0.66667 |
| Alx1_KD | 11 | 17 | 0.64706 |
| Hnf6_KD | 9 | 14 | 0.64286 |
| Gcm_KD | 7 | 11 | 0.63636 |
| TBr_KD | 4 | 7 | 0.57143 |
| FoxA_KD | 9 | 16 | 0.5625 |
| Otx_KD | 1 | 2 | 0.5 |
| Hox_KD | 6 | 13 | 0.46154 |
| SoxB1_KD | 2 | 5 | 0.4 |
| Pmar1_MOE | 11 | 28 | 0.39286 |
| Eve_KD | 3 | 8 | 0.375 |
| Alx1_MOE | 5 | 15 | 0.33333 |
| Blimp1_KD | 3 | 9 | 0.33333 |
| Dri_KD | 4 | 16 | 0.25 |
| SoxB1_MOE | 7 | 39 | 0.17949 |
| Eta1_KD | 2 | 18 | 0.11111 |
| GataC_KD | 0 | 2 | 0 |
| Pmar1_KD | 0 | 2 | 0 |
| Brn_KD | 0 | 2 | 0 |
| FoxB_KD | 0 | 2 | 0 |
| total | 113 | 8.74211 | 0.42164 |
| KD only | 90 | 186 | 0.48 |
| MOE only | 23 | 82 | 0.28 |

FIG. 15 confirms these observations but furthermore indicates genes which often react to perturbations according to experimental data (pks, nrl, fvmo, alx1 and bra) and genes which rarely react in accordance with experimental data, like sm50, sm27 and ficolin, whose unexpected behavior might be caused by the great number of upstream interactions varying with the different parameter sets. Other genes, which are important regulatory genes, like foxb, foxa and eve also fail to reproduce the experimental data exceedingly often. Although both sets of genes reproduce the experimental data unsatisfactorily, the genes in the second set have important regulatory roles in contrast to the afore mentioned, so that we consider these genes to lack refinement more urgently.

TABLE 3
Number of parameter sets used and overall accordance to experimental
data.

| parameter sets | accordance |
|---|---|
| 0-20 | 42.179 |
| 0-50 | 42.537 |
| 0-100 | 41.791 |
| 0-200 | 41.418 |
| 0-300 | 42.164 |
| 0-400 | 42.537 |
| 0-500 | 42.537 |
| 0-600 | 42.537 |
| 0-700 | 42.164 |
| 0-999 | 42.164 |

Summarizing, the results indicate the need for a detailed analysis of the regulatory interactions involving ets1 and soxb1, while the regulation of other genes needs to be checked as well (foxb, foxa and eve).

Overall, the model reproduces 42% of the experimental data. This further indicates that the model needs refinement in order to increase accordance with experimental data. This refinement must heavily rely on more experimental data, since only a small fraction of the 5920 possible effects of the modeled MASO perturbations on the analyzed genes is associated with experimental data.

Comparison with Random Networks

Two random networks with comparable features were constructed by randomly swapping edges in the original ODE model as described in Methods.

The randomized networks were simulated under control and perturbation conditions using sampled parameter sets as the original model, except that for the randomized models, only 100 parameter sets were used instead of 800 for the original model, due to the findings described in the last section and Table 3. The randomized models also contained three identical submodels which only differ in their temporal inputs. The two randomized models analyzed here were able to reproduce only 20.15% and 23.5% of the experimental data. We also checked one randomized model in which we switched 30000 instead of 3000 edges with similar results.

Although this is in the range of the endoderm portion of the original model, no randomized model exceeded this accordance significantly, as does the PMC portion of the complete model (see Table 4). Also, a combination of any three of the 8 randomized networks did not yield an overall accordance with experimental data greater than 25%. We therefore assume that the computed accordance of the randomized networks is dependent only on the general topological features of the model (like size and connectivity), the experimental data and the temporal inputs. This indicates that the accordance between a model of comparable general features as the one described here using the specified temporal inputs and the experimental data used here can be expected to be less than 25% by chance alone.

TABLE 4
Using simulation results for different embryonic territories,
the achieved accordance with experimental data are shown.
All 800 parameter sets are used for the table.

| territory | accordance(%) |
|---|---|
| total | 42 |
| endo | 21 |
| meso | 24 |
| PMC | 35 |

The accordance with experimental data expected by chance is thus about half the accordance observed using our model, indicating significantly improved validity of the Endomesoderm Network compared to random networks.

Results obtained on the Sea Urchin Endomesoderm Network with the methods of the present invention are furthermore described in detail in the publication Kühn et al. (2009). The publication Kühn et al. (2009), and in the present context in particular the section entitled “Reults and Discussion” of Kühn et al. (2009), is fully incorporated by reference.

### EXAMPLE 2

### Apoptosis

The in silico representation of the apoptosis network comprises 97 differential equations and 113 (all unknown) kinetic parameters. Predicted concentrations were compared with experimental data obtained from knock down experiments. Caspase C3 has been knocked down in Wi38 cells using siRNAs. In order to reflect the experimental knock down of caspase 3 in the simulation, the initial concentration of caspase 3 in the simulation was set to 20% of the concentration of caspase 3 in the control situation. In either case, i.e., control and knock down 400 simulations of the time-dependent behavior of the apoptosis pathway were performed. Results are shown in Table 5 below.

TABLE 5
Concentration of proteins and protein complexes of the apoptosis
pathway in apoptotic normal cells and cells with caspase 3 knock
down (20%) after the model has reached the equilibrium. The values
correspond to averages of 400 simulations.

| | | 80% Caspase | Kolmogorov- |
|---|---|---|---|
| | Control | 3-KO | Smimov-Test |
| XIAP:cl. Caspase 3-complex | 1.31 | 0.43 | 0.00 |
| Cleaved Caspase 9 | 0.35 | 0.10 | 0.00 |
| Caspase 9 | 0.68 | 0.90 | 0.00 |
| Smac:XIAP:cl. Caspase | 2.16 | 0.70 | 0.00 |
| 3-complex | | | |
| XIAP:cl. Caspase 9-complex | 0.86 | 0.48 | 0.00 |
| Smac:XIAP-complex | 5.54 | 9.05 | 0.00 |
| Cleaved Caspase 3 | 0.55 | 0.11 | 0.00 |
| Caspase 3 | 0.59 | 0.12 | 0.00 |
| Smac:XIAP:cl. Caspase | 1.41 | 0.63 | 0.00 |
| 9-complex | | | |

Comparison with experimental data for caspase 9 and cleaved caspase 9. In the experimental setting, knock down of caspase 3 caused a significant decrease of the amount of cleaved caspase 9 and a slight increase of (uncleaved) caspase 9. These results are in good agreement with the predictions made with the method according to the invention. As shown in FIGS. 5 and 6, the concentration of the cleaved from of caspase 9 decreases, while caspase 9 concomitantly increases.

### EXAMPLE 3

### Generating Computational Predictions of Knock-Down Effects on a Large Cancer Network

A Minimal Network for Predicting the Effects of Cancer Treatment

As a first step in the development and annotation of a minimal interaction network for cancer treatment we have taken advantage of a large body of information on cancer-relevant genes and their functional interactions. Cancer is probably one of the most complex diseases involving multiple genes and pathways (Bild, et al., 2006; Hanahan and Weinberg, 2000; Weinberg, 2007) and is considered to be a manifestation of severe functional changes in cell physiology, leading, e.g., to evasion of apoptosis and insensitivity to anti-growth signals. These functional changes are associated with key molecules and pathways involved in cancer onset and progression. Most cancer studies have focused on the consequences of abnormal activities of these pathways resulting from mutations of oncogenes and tumor suppressor genes (Kinzler and Vogelstein, 1996). Crucial for the regulation of cell proliferation and apoptosis are the recognition and integration of growth and death signals by the cellular signal transduction network, a complex network exhibiting extensive crosstalk. Positive feedback loops between pathways can induce transitions from inactive to permanently activated states leading to continuous cell proliferation and, hence, contribute to the pathogenesis of cancer (Kim, et al., 2007).

TABLE 6
Targeted therapeutic drugs in cancer. Selection of different anti-cancer
drugs that target cell surface receptors or downstream components of the initiated pathways.
Inhibition experiments relate to single or multiple model components that were inhibited.
These components are described in Table 9.

| Compound | Target protein | Target pathway | Inhibition experiments | Reference |
|---|---|---|---|---|
| Perifosine | RAC-beta serine/threonine | AKT Signaling | AKT2, AKTPI3K, | Van Ummersen et al. 2004, |
| | protein kinase | | IRSAKTPI3K, | Hennessy et al., 2005 |
| | | | mTORIRSAKTPI3K, | |
| | | | DvIAKT2 | |
| Wortmannin analogues | Phosphatidylinositol-4,5- | PI3K Cascade | PI3K, AKTPI3K, | Ng et al. 2001, Hennessy et al., 2005 |
| | bisphosphate 3-kinase | | IRSAKTPI3K, | |
| | | | mTORIRSAKTPI3K | |
| Metformin | Insulin receptor substrate-1 | IRS-signaling | IRS, IRSAKTPI3K, | Yuan et al. 2003 |
| | | | mTORIRSAKTPI3K | |
| Indirubin-3′-oxime | AMP-activated protein kinase | Glucagon signaling | AMPK | Meijer et al., 2003 |
| 15 a.a peptide | Extracellular regulated kinase | Raf Signaling | ERK, MEKERK | Horiuchi et al, Shen & Brown 2003 |
| PD-325901, ARRY-142886 | Dual specificity mitogen-activated | Raf Signaling | MEK, MEKERK | NCI, 2008, Huynh et al. 2007 |
| | protein kinase kinase 1 | | | |
| Staurosporine | Proteinkinase A | Glucagon signaling | PKA, PKCPKA | Kissau 2002 |
| Enzastaurin (LY-317615) | Proteinkinase C | Protein kinase | PKCPKA | Graff et al. 2005 |
| | | C Signaling | | |
| PD-0332991 | Cyclin dependent kinase | Cell cycle | CDKD | NCI, 2008 |
| AEG35156 | X-linked Inhibitor of apoptosis | Apoptosis | XIAP | Wegermann 2004 |
| FJ9 | Dishevelled | Wnt Signaling | DvIAKT2 | Fujii et al. 2007 |
| ATM Inhibitor (KU-0055933) | Ataxia telangiectasia mutated | Apoptosis | ATM | Madhusudan, and Middleton 2005 |
| UCN-01, OSU03012 | 3-phosphoinositide dependent | AKT Signaling | PDK1 | Hennessy, 2005, Tseng 2005 |
| | protein kinase-1 | | | |
| Imatinib (Glivec ®), | Abelson murine leukemia | Cell cycle | ABLSRC, | Karaman et al. 2008 |
| Dasatinib | | | HDACABLSRC | |
| FR901228 | Histone deacetylase | Cell cycle | HDACABLSRC | Piekarz 2001 |
| Obatoclax-Mesylate | B-cell lymphoma 2) | Apoptosis | Bcl2BclX | Wang 2007 |
| (GX15-070MS) | | | | |
| Obatoclax-Mesylate | Apoptosis regulator Bcl-X | Apoptosis | Bcl2BclX | Wang 2007 |
| (GX15-070MS) | | | | |
| STAT-induced-STAT- | Signal Transducers and | Cytokine Signaling | STAT | Monni 2001, Buitenhuis 2002 |
| inhibitor-1 (SSI-1) | Activators of Transcription | | | |
| CP-690550 | Janus kinase 1 | Cytokine Signaling | JAK | Karaman et al. 2008 |
| CP-690550 | Janus kinase 3 | Cytokine Signaling | JAK | Karaman et al. 2008 |
| Dasatinib(Spycel ®) | Proto-oncogene tyrosine-protein | Src Signaling | ABLSRC, | Karaman et al. 2008 |
| | kinase Src | | HDACABLSRC | |
| Indirubin-3′-oxime, | Glycogen synthase kinase-3beta | Wnt signaling | GSK3 | Patel et al. 2004, Mettey et al., 2003, |
| Aloisine A | | | | Meijer et al., 2003 |
| Everolimus(Certican ®) | Mammalian target of rapamycin | mTOR Signaling | MTORIRSAKTPI3K | Petroulakis, 2006 |
| Diferuloylmethane | Cyclin D | Cell cycle | CDKD | Kelland, 2000 |
| Sorafenib (Naxavar ®) | BRAF | Raf Signaling | RAF | Strumberg, 2005 |
| Sorafenib (Naxavar ®) | c-raf | Raf Signaling | RAF | Strumberg, 2005 |

The majority of current anti-cancer drugs are, at least nominally, directed against single targets, but often occurring together with many off-target effects. Most of these drugs have a direct inhibitory effect on the presumed target and the associated pathway (Table 6). For example, an important target pathway is the PI3K/AKT signaling pathway, because it is crucial to many aspects of cell growth and survival. It is affected by genomic aberrations leading to activation of the pathway in many cancers (Hennessy, et al., 2005). The AKT inhibitor Perifosine was therefore used in preclinical and clinical trials for several cancer entities (Van Ummersen, et al., 2004), for example prostate cancer. This drug prevents membrane localization, possibly by interacting with the PH domain of AKT. Wortmannin and LY294002 present anti-tumor activity in vitro and in vivo (Hennessy, et al., 2005). Metformin hydrochloride increases the number and/or affinity of insulin receptors on muscle and adipose cells, increasing the sensitivity to insulin at receptor and post-receptor binding sites (NCI Drug Dictionary, http://www.cancer.gov). Rapamycin (Rapamune, Wyeth Ayerst) is a specific inhibitor of mTOR (mammalian target of rapamycin) that functions downstream of AKT (Hay and Sonenberg, 2004). mTOR inhibitors are being tested in clinical trials for patients with breast cancer and other solid tumors (Chan, et al., 2005; Hidalgo and Rowinsky, 2000; Nagata, et al., 2004). In cells, Everolimus binds to the immunophilin FK Binding Protein-12 (FKBP-12) to generate an immunosuppressive complex that binds to and inhibits the activation of mTOR, a key regulatory kinase. mTOR inhibition is explored in an attempt to overcome Trastuzumab resistance caused by downregulated PTEN. Temsirolimus (Torisel; Wyeth) is an inhibitor of the kinase mTOR, which blocks the phosphorylation of S6K1 (Faivre, et al., 2006), and is used for the treatment of advanced renal cell carcinoma. Sorafenib (Nexavar) is an oral multikinase inhibitor against RAF-kinase, VEGFR-2, PDGFR, FLT-2 and c-KIT (Strumberg, 2005), which targets angiogenesis and tumor proliferation. It is approved for the treatment of patients with advanced renal cell carcinoma or kidney cancer resistant to interferon-alpha or interleukin-2 based therapies. MEK is a critical member of the MAPK pathway involved in growth and survival of cancer cells. PD-325901 is a new drug designed to block this pathway and to kill cancer cells. PD-0332991 selectively inhibits cyclin-dependent kinases particularly CDK4, which may inhibit retinoblastoma (Rb) protein phosphorylation. Inhibition of Rb phosphorylation prevents Rb-positive tumor cells from entering the S phase of the cell cycle, resulting in suppression of DNA replication and decreased tumor cell proliferation. AEG35156 selectively blocks the cellular expression of X-linked inhibitor of apoptosis protein (XIAP), an inhibitor of apoptosis that is overexpressed in many tumors. This agent reduces the total levels of XIAP in tumor cells, working synergistically with cytotoxic drugs to overcome tumor cell resistance to apoptosis. Another compound, FJ9, disrupts the interaction between the Frizzed-7 Wnt receptor and the PDZ domain of Dishevelled, down-regulating canonical Wnt signaling and suppressing tumor cell growth (Fujii, et al., 2007). Binding to the ATP-binding site, Enzastaurin hydrochloride selectively inhibits protein kinase C beta.

Important signaling pathways crucial for cell growth and survival are frequently activated in human cancer due to genomic aberrations including mutations, amplifications and rearrangements. An ever increasing number of rationally designed small molecule inhibitors directed against growth and survival pathways such as the RAS-RAF-MEK-ERK, PI3K-AKT-mTOR, or the JAK-STAT signaling pathways are now entering clinical testing for the treatment of cancer (Hennessy, et al., 2005; McCubrey, et al., 2008; Van Ummersen, et al., 2004). Nevertheless, many inhibitors fail in clinical testing due to unexpected toxicities caused by previously unknown “off-targets”, or because the drug target itself is involved in multiple functional interactions that are sensitive to deregulation. In addition, clinical failure of targeted drugs are also caused by the existence of unexpected feedback loops, compensatory up-regulation of alternative signaling pathways, or drug resistance mutations all of which circumvent the effects of target inhibition and allow tumor cell survival and proliferation (Burchert, et al., 2005).

As these examples show, predictive models therefore should include many (or ideally all) of the relevant functional interactions in order to cope with the complexity of multiple targets and crosstalk between pathways. Such models could provide significant support for the development of novel targeted drugs by revealing unexpected side effects or insensitivities of the patient. However, so far, computational modeling of cancer processes has been focused mainly on individual sub-pathways such as RAF (Kim, et al., 2007), AKT (Araujo, et al., 2007), or WNT signaling (Kim, et al., 2007). The integration of several isolated pathways into a larger framework, which also captures crosstalk between pathways, might however be crucial for the prediction of drug action. In this perspective we tested the power of computational prediction by simulating the effects of drug action on a “minimal” interaction network of cancer-relevant processes described in the next paragraph. Having agglomerated information about drugs, their molecular targets, or set of targets, and the cellular interaction network they function in, the next step is to translate the inhibitory effects in the computer. This is done by relating the drugs to their intended drug target proteins and to simulate the effect of inhibition of the drug targets by the inhibition of single or multiple model components that are associated with them (Table 6).

Automation of Model Population and Annotation Workflows

Selection of the key components that constitute a minimal predictive interaction network for cancer treatment is mainly based on biological function. Computational modeling of drug effects requires the translation of the pathway schemas (FIG. 7A) into computer models that can carry information on the concentrations of the model components and on the kinetics of the reactions these components are involved in. This process contains the design of suitable computer objects, the implementation of the reactions, the assignment of kinetic laws to these reactions and the model analysis (FIG. 7B).

Computational tools that support model population, simulation and analysis build the basis of systems biology (Wierling, et al., 2007). Several modeling tools have been proposed recently, for example CellDesigner (Funahashi, et al., 2003), E-Cell (Tomita, et al., 1999), Gepasi (Mendes, 1993; Mendes, 1997) and its successor Copasi (Hoops, et al., 2006), ProMoT/Diva (Ginkel, et al., 2003), Virtual Cell (Loew and Schaff, 2001; Slepchenko, et al., 2003) and tools integrated in the Systems Biology Workbench (Hucka, et al., 2002). Most of these systems are designed for the manual analysis of small models with a few reactions. However, the development of a relevant predictive model requires information about a large number of components, reactions and kinetic parameters. Thus, automation of the modeling process requires support in the handling of large networks at several steps, for example, in the annotation of the reaction networks, the visualization of model fluxes, the numerical integration of differential equations, and the model analysis.

In this work we demonstrate such an approach using the modeling and simulation system PyBioS (Wierling, et al., 2007). PyBioS (http://pybios.molgen.mpg.de) supports the automatic generation of models by providing interfaces to pathway databases, which allows rapid and automated access to relevant reaction systems. Much of the existing knowledge on cancer-relevant reaction networks is agglomerated in pathway databases, such as BioCyc (Karp, et al., 2005), KEGG (Kanehisa, et al., 2006) and Reactome (Joshi-Tope, et al., 2005; Vastrik, et al., 2007), allowing direct import into the PyBioS system.

Our analysis is composed of three parts, the establishment of a model comprising cancer relevant pathways, the introduction of inhibitions of model components, e.g., due to the effects of a drug, and the model analysis. The prototype of a predictive network to simulate the effects of drug target inhibition was compiled by combining information from literature and public pathway databases for twenty different signaling pathways with focus on the hallmarks of cancer. Currently, the network comprises 767 components with 1913 individual reactions (for a summary see Table 7).

TABLE 7
List of model components included in the annotated human cancer
network.
Network components

| | |
|---|---|
| Reactions | 1913 |
| Pathways | 20 |
| Rb/E2F pathway | |
| DNA Damage Checkpoints | |
| DNA repair | |
| IGF-1 signaling | |
| Signaling by EGFR | |
| NGFR signalling | |
| TGFbeta signalling | |
| BMP signaling | |
| Hedgehog signaling | |
| MAP kinase cascade | |
| Extrinsic apoptosis | |
| Intrinsic apoptosis | |
| Toll Like Receptor 10 (TLR10) Cascade | |
| Toll Like Receptor 3 (TLR3) Cascade | |
| Cytokine Signaling/JAK/STATsignaling | |
| Wnt signaling | |
| E-cadherin pathway | |
| PLC signalling | |
| Glucagon signaling | |
| Proteins | 326 |
| Mutated genes | 8* |
| Druggable genes | 18** |
| Complexes | 354 |

*Cancer Gene Census; http://www.sanger.ac.uk/genetics/CGP/Census/;
**Druggable genes based on Russ and Lampel (2005).

While pathway annotation is to a large extent still carried out manually, tools for automated annotation that store and facilitate the upload of static models into modeling systems are available. Pathway annotation of our prototype network was performed with the Reactome Curator Tool that automates the process of collecting and storing information of signaling pathways (http://www.reactome.org). The entire network consists of twenty different pathways, which constitute signal transduction cascades activated by stimuli such as growth factors (EGF, NGF, IGF-1, TGF-beta), cell proliferation (Wnt, Rb, Notch receptors, Hedgehog), cytokines (Interleukin 2, STAT-JAK), inflammation (Toll-like receptors), apoptosis (TNF-alpha, FAS, TRAIL) and metabolic regulation (G-protein-coupled receptors). The reactions were imported into the PyBioS modeling system and the corresponding mathematical ODE model was automatically created from the reaction system.

The Monte Carlo Approach: Modeling in the Face of Uncertainty

Modeling is a trade-off between model size and prediction precision. Models with high precision generate computational predictions of large detail based on a rather small number of model components. Those predictions are however often compromised by the difficulties to measure the relevant parameters under in vivo conditions, compounded by ignoring crosstalk between the different pathways involved. Parameter fitting strategies do, however, suffer from the general difficulty of any such approaches, the fact, that even incorrect models can in general be fitted quite well, if enough parameters can be varied to generate the fit.

In particular, medically relevant models are likely to involve a large number of model components having consequences for the model precision. The strategy proposed in this perspective is designed for this purpose. The reactions involved in the model consist of a small number of different reaction types such as synthesis reactions, complex and product formations and degradation reactions described by irreversible mass action kinetics

$$k * {\prod }_{i = 1}^{n} ( {S}_{i} )$$

where k is a kinetic constant and Sᵢ is the concentration of the i^{th} substrate. Reversible reactions are described by separate forward and backward reactions each using an irreversible mass action kinetic. For complex formation and dissociation a reversible mass action kinetic with a dissociation constant of 100 [a.u.] has been applied. Synthesis and decay reactions have been introduced where appropriate. The rate laws of the model, which have been applied, are summarized in Table 8.

TABLE 8
Different types of reaction kinetics.

| Reaction | Biochemical equation | Rate law |
|---|---|---|
| Synthesis | v₀: → S2 | v₀ = k₀ |
| Complex | v₁: S1 + S2 [symbol] S1:S2 | v₁ = kf[S1][S2] − (kf\|K_{D})[S1:S2] |
| formation | | with K_{D} = 100 |
| Formation of | v₂: S1 → S2 | v₂ = k1[S1] |
| product | | |
| Degradation | v₃: S2 → | v₃ = k₃ S2 with k = 10^{-3 (}*⁾ |

In our modeling approach we focus on predicting differences between different states of the same network, e.g. the biological network with or without inactivating different sets of drug targets, representing a simplified model of the effects of drug treatment. To compensate for the uncertainty in many of the parameters, the components of the parameter vector are chosen from appropriate probability distributions, reflecting available knowledge. In the set of simulation runs described here, in particular, unknown kinetic parameters have been sampled from a log-normal distribution with mean μ=2.5 and standard deviation σ=0.5. Each parameter vector and each vector of input values was used to model both the normal control state as well as the ‘treated’ state, corresponding to the inhibition experiment so that the initial difference of the two states is due to changes in only one parameteror a small set of model parameters. For simulation of the different inhibition experiments the model components listed in Table 9 were initialized with fixed concentrations of 0.0 [a.u.], corresponding to a complete elimination of the target protein. Control and treatment simulations were repeated 250 times with different parameter vectors until steady state levels of all components were reached. (FIG. 8).

The difference in model behavior between the ‘treated’ and the ‘untreated’ state was analyzed by comparing the steady state concentrations for each individual model component. Differences in the final steady state values of the two states for the model components across the successful simulation runs are analyzed for statistical significance using the Kolmogorov-Smirnov test (Conover, 1971) to identify those model components that are influenced by the specific therapy.

Systematic Analysis of Drug Target Inhibition

As a test for the proposed framework, we compared the behavior of the model components in the unperturbed states with the treated states according to the different inhibition experiments listed in Table 9. The computational inhibition of drug targets gives the opportunity to predict consequences on several levels. On the one hand, it allows the overall evaluation of the sensitivity of the treatment by computing the set of statistically significant changes according to the steady state concentrations. On the other hand, it enables the identification of specific changes in pathway components such as direct effects (desired effects of the therapy) and indirect effects (potential undesired side effects of the therapy).

TABLE 9
Inhibition experiments simulating the effect of anti-cancer drugs (compare Table 6)
and associated model components that were inhibited in the respective experiment.

| Experi- | | Targeted | Targeted | Targeted | Targeted | Targeted | Targeted |
|---|---|---|---|---|---|---|---|
| ment | Inhibition | model | model | model | model | model | model |
| ID | experiment | component 1 | component 2 | component 3 | component 4 | component 5 | component 6 |
| 1 | AKT2 | RAC-beta | PIP3: Phosphorylated | — | — | — | — |
| | | serine/threonine | PKB complex | | | | |
| | | protein kinase | | | | | |
| 2 | PI3K | PI3K | — | — | — | — | — |
| 3 | AKTPI3K | RAC-beta | PIP3: Phosphorylated | PI3K | — | — | — |
| | | serine/threonine | PKB complex | | | | |
| | | protein kinase | | | | | |
| 4 | PDK1 | 3- | — | — | — | — | — |
| | | phosphoinositide | | | | | |
| | | dependent protein | | | | | |
| | | kinase-1 | | | | | |
| 5 | DvlAKT2 | Wnt:Dvl:Fz | RAC-beta | PIP3: Phosphorylated | — | — | — |
| | | | serine/threonine | PKB complex | | | |
| | | | protein kinase | | | | |
| 6 | IRS | phospho-IRS-1 | — | — | — | — | — |
| 7 | IRSAKTPI3K | phospho-IRS-1 | RAC-beta | PIP3: Phosphorylated | PI3K | — | — |
| | | | serine/threonine | PKB complex | | | |
| | | | protein kinase | | | | |
| 8 | mTORIRSAK | mTOR | Activated | RAC-beta | PIP3: Phosphorylated | PI3K | phospho-IRS-1 |
| | TPI3K | | mTORC1 | serine/threonine | PKB complex | | |
| | | | | protein kinase | | | |
| 9 | AMPK | Activated AMPK | — | — | — | — | — |
| | | heterotrimer | | | | | |
| 10 | ERK | ERK1 | — | — | — | — | — |
| 11 | MEK | MEK1 | — | — | — | — | — |
| 12 | MEKERK | ERK1 | MEK1 | — | — | — | — |
| 13 | PKA | PKA | PKA | PKA | — | — | — |
| | | regulatory | catalytic | catalytic | | | |
| | | subunit | subunit | subunit | | | |
| | | | | [nuc.] | | | |
| 14 | PKCPKA | Activated | Activated | PKA | PKA | PKA | — |
| | | PKC alpha | PKC beta | regulatory | catalytic | catalytic | |
| | | | | subunit | subunit | subunit | |
| | | | | | | [nucl.] | |
| 15 | CDKD | Cyclin D | Cdk4/6 | — | — | — | — |
| 16 | XIAP | XIAP | — | — | — | — | — |
| 17 | ATM | ATM serine- | — | — | — | — | — |
| | | protein kinase | | | | | |
| 18 | ABLSRC | ABL | SRC [ | — | — | — | — |
| 19 | HDACABLS | HDAC1] | ABL | SRC | — | — | — |
| | RC | | | | | | |
| 20 | Bcl2BclX | Bcl-2 protein | Apoptosis | — | — | — | — |
| | | | regulator Bcl-X | | | | |
| 21 | STAT | STAT 5 | — | — | — | — | — |
| 22 | JAK | Jak1 | Jak3 | — | — | — | — |
| 23 | GSK3 | GSK3B | — | — | — | — | — |
| 24 | RAF | c-Raf | B-Raf | — | — | — | — |

Global Analysis Monitors Differences in Drug Action

FIG. 9 summarizes the overall statistics. Perturbation sensitivity expressed by the number of significant changes with the different inhibition experiments is rather variable (FIG. 9A). Whereas some inhibition domains as for example the inhibition of the activated form of AKT2 enzyme (model component PIP3:Phosphorylated PKB), affect more than 60 different model components either by inhibition of a single (IRS) or multiple targets (mTOR, IRS, AKT2 and PI3K) in the different inhibition experiments, others are very specific, for example STAT inhibition, affecting less than 10 out of 767 model components. On the other hand, target sensitivity is fairly high and most model components are robust with respect to inhibitory effects (FIG. 9B). The largest fraction of model components (520 out of 767) is not affected by any of the inhibition experiments. Most significant changes are only observed in a single (73) or less than five (138 for >=2 and <=5) different inhibition experiments. Only a minor fraction of model components (35) shows effects in a larger number (>=8) of inhibition experiments. Components affected by a large number of drug target inhibitions are those, which play central roles in the signaling pathways, for example, GSK3β and its phosphorylated form or GSK3β associated with APC and axin from the Wnt signaling pathway, or central components of mTOR signaling. In general, the selected drugs and inhibition domains (Table 9) fall into three different groups as indicated by principal component analysis (FIG. 9C). Of particular interest is the group of IRS, AKT2, PI3K, PDK1 and combinations thereof since these inhibition experiments affect by far the most model components.

Targeting AKT Signaling Reveals Direct and Indirect Downstream Effects

Complementary to the global analysis, the modeling approach generates detailed predictions for key treatments. Several inhibition experiments target the direct or indirect inactivation of AKT signaling, such as the phosphorylated GSK3β (phospho-GSK3beta), and the TSC1:Inhibited TSC2-1-P complex. These components influence cancer relevant cellular read-outs as for example proliferation and apoptosis. A schematic view of these intervention points and read-outs is shown in FIG. 10. Inhibition of the respective model components reveals direct effects as well as indirect effects, illustrating the importance of pathway crosstalk for drug side effects.

FIG. 11 shows selected results illustrating either direct (left panel) or indirect effects (right panel) of the inhibition experiments. For example, a reduction in the steady state concentration of phosphorylated GSK3β (phospho-GSK3beta) can be seen as a direct effect of the AKT2 inhibition alone (AKT2) or in combination with PI3K inhibition (AKTPI3K) (FIG. 11A, FIG. 11G). A direct reduction in the concentration of the phosphorylated GSK3β (phospho-GSK3beta), the unphosphorylated form of which plays an important role in Wnt signaling, is due to the inhibition of active AKT2 and PI3K (AKT2, PI3K). The PDK inhibition (FIG. 11C) has a direct effect in the phosphorylation of AKT2, and results in a down regulation of the PIP3:phosphorylated-PKB complex. It is well known that PIP3 recruits the serine/threonine kinases PDK1 and AKT2 to the plasma membrane, where AKT2 is activated by PDK1-mediated phosphorylation. In the IRS inhibition experiment, the inhibition of PI3K is considered a direct effect due to inhibition of the phosphorylated (activated) form of the insulin receptor substrate (IRS), a key activator of PI3K (FIG. 11E), leading to a subsequent reduction of the steady state concentration of the phospho-IRS:PI3K complex.

Complementary, the modeling strategy identifies many indirect effects. S6K1 is a component of the small (40-S) ribosomal subunit and enables this subunit to participate in ribosome formation and thus in protein synthesis. The phosphorylated form of S6K1 has been found to be down regulated in the inhibition experiments AKT and AKTP3K (FIG. 11B, FIG. 11H). The inhibition of the S6K phosphorylation is due to a downstream component of the PI3K cascade in the AKT signaling pathway and downstream effects on mTOR signaling. The phosphorylation of GSK3β (FIG. 11D), is indirectly controlled by PDK (inhibition experiment PDK1) since the inhibition of PDK leads to the down regulation of phospho-GSK3β (FIG. 11D), which is due to the inhibition of AKT. As a further indirect effect, inhibition of activated IRS (inhibition experiment IRS) leads to the reduction of the phosphorylation of TSC2 (FIG. 11F).

Co-Expression Clusters of Predicted Effects of Inhibition Experiments Show Accordance to Literature Knowledge

Many model components show similar expression patterns across the entire panel of the inhibition experiments and several of these co-expression clusters of drug action can be explained by previous data from literature. FIG. 12 shows a specific example of model components affected by the inhibition experiments involving AKT.

AKT activation is driven by membrane localization initiated by binding of the pleckstrin homology domain (PHD) to phosphatidylinositol-3,4,5-trisphosphate (PIP3) followed by phosphorylation of the regulatory amino acids serine 473 and threonine 308 (Vivanco and Sawyers, 2002). The pathological association of AKT with the plasma membrane is a common thread that connects AKT to cancer. For drug effects based on inhibition of the active form of AKT (inhibition experiments AKT2, Dv1AKT2, AKTPI3K, IRSAKTPI3K, mTORIRSAKTPI3K, cf. Table 9) the down regulation of downstream components can be identified (FIG. 12). Furthermore, the inhibition experiments PI3K and PDK1 have shown similar inhibited components compared to those based on AKT inhibition. This observation agrees with literature data where AKT is identified as a primary downstream mediator of the effects of PI3K and PDK1 (Hennessy, et al., 2005).

Several of the components in the IRS inhibition experiment show a similar behavior as AKT2. However, the IRS inhibition experiment is characterized by an up regulation of three specific components (RAC-β serine/threonine protein kinase [AKT2], its complex with the PKB regulator [PKB:PKB Regulator; AKT2 is a synonym for PKB] and PI3K) whereas the phopho-IRS:PI3K complex is down regulated. The inhibition of the components eEF2K-P, elF4G-P, Phosphorylated 40S small ribosomal protein, elF4B-P, TSC1:Inhibited TSC2-1-P, S6K1-P, Activated mTORC1, Inhibited TSC2-1-P and Phosphorylated AKT complex is due to the AKT inhibition. Phosphorylation of TSC1:TSC2 complex by AKT1 results in the TSC1:Inhibited TSC2-1-P complex and its subsequent degradation through the proteosome pathway. The down regulation of the PDE3B phosphorylation is due to the AKT inhibition and is also noticed in the PI3K inhibition experiment. This confirms reports that PI3K inhibition through Wortmannin inhibits phosphorylation and activation of PDE3B and the anti-lipolytic effect of insulin (Rahn, et al., 1994). Furthermore, the PI3K influence in the phosphorylation of S6K is well-known, since, due to the activation by PI3K, mTOR phosphorylates and activates S6K to increase translation of mRNA (Rhodes and White, 2002; Saltiel and Kahn, 2001).

Monitoring Network Dependencies with Sensitivity Analysis

Sensitivity analysis is used to understand the relationship and interactions between the different model components. Several methods have been proposed to quantify these interactions. For example, metabolic control analysis (MCA) investigates the sensitivity of model components against infinitely small perturbations in the underlying system (Klipp, et al., 2005). In Cho, et al. (2003) a multiparametric sensitivity analysis (MPSA) has been introduced. This method allows the identification of those parameters for which the mathematical model is very sensitive with an approach based on Monte Carlo simulations. In Jiang, et al. (2007) the local behavior of the system is analyzed by calculating time-dependent quantitative control values. The parameter sensitivity trajectories in time are used to determine the sensitivity of the metabolites against infinitely small changes in kinetic parameters.

In addition to the inhibition of specific model components by 100%, we have performed a sensitivity analysis in order to explore the behavior of the model components on smaller variations of inputs. Small inhibitions (10%) were performed with 29 model components, one at a time, that were analysed in the different inhibition experiments described in the previous sections. For each of these model components we initialized the ODE model for the inhibition experiment with the steady state values of the control state except for the selected component that is fixed to 90% of its steady state value. Subsequently the change in steady state for the 10% inhibition is computed. The quantified sensitivity of each model component in case of 10% reduction is given by

$${Sen}_{i}^{j} = - 1.0 * \frac{{S}_{i}^{control} - {S}_{i}^{j}}{{S}_{j}^{control} - 0.9 * {S}_{j}^{control}} = - 10.0 * \frac{{S}_{i}^{control} - {S}_{i}^{j}}{{S}_{j}^{control}}$$

where i=1, . . . , n is the index over all components, j=1, . . . , m is the index of the inhibited target. Accordingly, Sᵢ^{control} denotes the steady state concentration of the component with index i in the control run and Sᵢ^{j} denotes the steady state concentration of component i in the 10% inhibition model of the drug target with index j.

Clustering of the resulting sensitivity values reveals groups of model components that show similar sensitivity patterns across the set of 29 inhibition experiments.

FIG. 13 shows a selected cluster of model components that display a high sensitivity to AKT2 (synonym RACbetaserine). A slight reduction of inactive AKT2 leads to a significant change in active AKT2 (PIP3:Phosphorylated PKB complex) and its subsequent targets, TSC1:inhibited TSC2 and phospho-GSK3beta. Sensitivity analysis reveals that the phosphorylated form of GSK3beta (phospho-GSK3beta) is also sensitive to small changes in various other drug targets (e.g., SRC, GSK3, PIP3complex, PDK1, PI3K).

### REFERENCES CITED IN EXAMPLE 1

1. Davidson E H: The sea urchin genome: Where will it lead us? Science 2006, 314:939.
2. Driesch H: Entwicklungsmechanische Studien I. Zeitschrift fuer wissenschaftliche Zoologie 1891, 53:160.
3. Davidson E H, Erwin D H: Gene regulatory networks and the evolution of animal body plans. Science 2006, 311:796.
4. Davidson EH, al: A provisional regulatory gene network for specification of endomesoderm in the sea urchin embryo. Developmental Biology 2002, 246:162-190.
5. Howard E, Newman L, Oleksyn D, Angerer R, Angerer L: SpKr1: a direct target of β-catenin regulation required for endoderm differentiation in sea urchin embryos. Development 2001, 128:365-375.
6. Livi C B, Davidson E H: Expression and function of blimp1/krox, an alternatively transcribed regulatory gene of the sea urchin edomesoderm network. Developmental Biology 2006, 293:513-525.
7. Yuh C H, Dorman E R, Davidson E H: Brn1/2/4, the predicted midgut regulator of the endo16 gene of the sea urchin embryo. Developmental Biology 2005, 281:286-298.
8. Oliveri P, Walton K D, Davidson E H, McClay D R: Repression of mesodermal fate by FoxA, a key endoderm regulator of the sea urchin embryo. Development 2006, 133:4173-4181.
9. Lee P Y, Davidson E H: Expression of SpGataE, the Strongylocentrotus purpuratus ortholog of vertebrate GATA4/5/6 factors. Gene Expression Patterns 2004, 5:161-165.
10. Howard-Ashby M, Materna S C, Brown C T, Chen L, Cameron R A, Davidson EH: Identification and characterization of homeobox transcription factor genes in Strongylocentrotus purpuratus, and their expression in embryonic development. Developmental Biology 2006, 300:74-89.
11. Oliveri P, Carrick D M, Davidson E H: A regulatory Gene Network that directs micromere specification in the sea urchin embryo. Developmental Biology 2002.
12. Li X, Chuang C K, Mao C A, Angerer L M, Klein W H: Two Otx proteins generated from multiple transcripts of a single gene in strongylocentrotus purpuratus. Developmental Biology 1997, 187:253-266.
13. Wikramanayake A H, Peterson R, Chen J, Huanf L, Bince J M, McClay D R, Klein W H: Nuclear β-catenin dependent Wnt8 signaling in vegetal cells of the early sea urchin embryo regulates gastrulation and differentiation of endoderm and mesoderma cell lineages. Genesis 2004, 39:194-205.
14. Endomesoderm and Ectoderm Models [[http://sugp.caltech.edu/endomes/]].
15. Longabaugh W J R, Davidson E H, Bolouri H: Computational representation of developmental genetic regulatory networks. Developmental Biology 2005, 283:1-16.
16. Zi Z, Cho K H, Sung M H, Xia X, Zheng J, Sun Z: In silico identification of the key components and steps in IFN-induced JAK-STAT signaling pathway. FEBS Letters 2005, 579:1101-1108.
17. Nijhout H F: The nature of robustness in development. BioEssays 2002, 24:553-563.
18. Milo R, Kashtan N, Itzkovitz S, Newman M E J, Alon U: Uniform generation of random graphs with arbitrary degree sequences. arXiv:cond-mat/0312028 2003.
19. QPCR Data Relevant to Endomesoderm Network [[http://sugp.caltech.edu/endomes/qper.html]].
20. Smith J, Theodoris C, Davidson E H: A gene regulatory network subcircuit drives a dynamic pattern of gene expression. Science 2007, 318:794-797.
21. Angerer L M, Angerer R C: Regulative development of the sea urchin embryo: Signaling cascades and morphogen gradients. Cell and Developmental Biology 1999, 10:327-334.
22. Freeman F: Feedback control of intercellular signalling in development. Nature 2000, 408:313-319.
23. de Jong H: Modeling and Simulation of Genetic Regulatory Systems: A Literature Review. Journal of Computational Biology 2002, 9:67-103.
24. Kühn C, Kühn A, Poustka A J, Klipp E: Modeling Development: Spikes of the Sea Urchin. Genome Informatics 2007, 18:75-84.
25. Revilla-i Domingo R, Oliveri P, Davidson E H: A missing link in the sea urchin embryo gene regulatory network: hesC and the double-negative specification of micromeres. Proc Natl Acad Sci USA 2007, 104(30):12383-12388.
26. Kitano H: Biological Robustness. Nature Reviews Genetics 2004, 5(11).
27. Stelling J, Sauer U, Szallasi Z, Doyle F J, Doyle J: Robustness of cellular functions. Cell 2004, 118:675-685.
28. Schilstra M J, Bolouri H: The logic of gene regulation. In 3rd Int. Conf. on Systems Biology 2002.
29. Klipp E, Herwig R, Kowald A, Wierling C, Lehrach H: Systems Biology in Practice. Weinheim: Wiley-VCH2005.
30. Wierling C, Herwig R, Lehrach H: Resources, standards and tools for systems biology. Brief Funct Genomic Proteomic 2007, 6(3):240-251.
31. van Rossum G, de Boer J: Interactively Testing Remote Servers Using the Python Programming Language. CWI Quarterly 1991, 4:283-303.
32. Karaman M W, Herrgard S, Treiber D K, et al. A quantitative analysis of kinase inhibitor selectivity. Nature Biotech. 2008, 26(1):127-132.

### REFERENCES CITED IN EXAMPLE 3

Araujo, R. P., Liotta, L. A. and Petricoin, E. F. (2007) Proteins, drug targets and the mechanisms they control: the simple truth about complex networks, Nat Rev Drug Discov, 6, 871-880.
Bild, A. H., Potti, A. and Nevins, J. R. (2006) Linking oncogenic pathways with therapeutic opportunities, Nat Rev Cancer, 6, 735-741.
Bruder, C. E., Piotrowski, A., Gijsbers, A. A., Andersson, R., Erickson, S., de Stahl, T. D., Menzel, U., Sandgren, J., von Tell, D., Poplawski, A., Crowley, M., Crasto, C., Partridge, E. C., Tiwari, H., Allison, D. B., Komorowski, J., van Ommen, G. J., Boomsma, D. I., Pedersen, N. L., den Dunnen, J. T., Wirdefeldt, K. and Dumanski, J. P. (2008) Phenotypically concordant and discordant monozygotic twins display different DNA copy-number-variation profiles, Am J Hum Genet, 82, 763-771.
Burchert, A., Wang, Y., Cai, D., von Bubnoff, N., Paschka, P., Muller-Brusselbach, S., Ottmann, O. G., Duyster, J., Hochhaus, A. and Neubauer, A. (2005) Compensatory PI3-kinase/Akt/mTor activation regulates imatinib resistance development, Leukemia, 19, 1774-1782.
Chan, S., Scheulen, M. E., Johnston, S., Mross, K., Cardoso, F., Dittrich, C., Eiermann, W., Hess, D., Morant, R., Semiglazov, V., Borner, M., Salzberg, M., Ostapenko, V., Illiger, H. J., Behringer, D., Bardy-Bouxin, N., Boni, J., Kong, S., Cincotta, M. and Moore, L. (2005) Phase II study of temsirolimus (CCI-779), a novel inhibitor of mTOR, in heavily pretreated patients with locally advanced or metastatic breast cancer, J Clin Oncol, 23, 5314-5322.
Cho, K.-H., Shin, S.-Y., Kolch, W. and Wolkenhauer, O. (2003) Experimental Design in Systems Biology, Based on Parameter Sensitivity Analysis Using a Monte Carlo Method: A Case Study for the TNFalpha-Mediated NF-kappa B Signal Transduction Pathway, SIMULATION, 79, 726-739.
Conover, W. J. (1971)Practical nonparametric statistics. Wiley & Sons, New York.
Faivre, S., Kroemer, G. and Raymond, E. (2006) Current development of mTOR inhibitors as anticancer agents, Nat Rev Drug Discov, 5, 671-688.
Fujii, N., You, L., Xu, Z., Uematsu, K., Shan, J., He, B., Mikami, I., Edmondson, L. R., Neale, G., Zheng, J., Guy, R. K. and Jablons, D. M. (2007) An antagonist of dishevelled protein-protein interaction suppresses beta-catenin-dependent tumor cell growth, Cancer Res, 67, 573-579.
Funahashi, A., Tanimura, N., Morohashi, M. and Kitano, H. (2003) CellDesigner: a process diagram editor for gene-regulatory and biochemical networks, Biosilico, 1, 159-162.
Futreal, P. A., Coin, L., Marshall, M., Down, T., Hubbard, T., Wooster, R., Rahman, N. and Stratton, M. R. (2004) A census of human cancer genes, Nat Rev Cancer, 4, 177-183.
Gills, J. J., Holbeck, S., Hollingshead, M., Hewitt, S. M., Kozikowski, A. P. and Dennis, P. A. (2006) Spectrum of activity and molecular correlates of response to phosphatidylinositol ether lipid analogues, novel lipid-based inhibitors of Akt, Mol Cancer Ther, 5, 713-722.
Ginkel, M., Kremling, A., Nutsch, T., Rehner, R. and Gilles, E. D. (2003) Modular modeling of cellular systems with ProMoT/Diva, Bioinformatics, 19, 1169-1176.
Hanahan, D. and Weinberg, R. A. (2000) The hallmarks of cancer, Cell, 100, 57-70.
Hay, N. and Sonenberg, N. (2004) Upstream and downstream of mTOR, Genes Dev, 18, 1926-1945.
Hennessy, B. T., Smith, D. L., Ram, P. T., Lu, Y. and Mills, G. B. (2005) Exploiting the PI3K/AKT pathway for cancer drug discovery, Nat Rev Drug Discov, 4, 988-1004.
Hidalgo, M. and Rowinsky, E. K. (2000) The rapamycin-sensitive signal transduction pathway as a target for cancer therapy, Oncogene, 19, 6680-6686.
Hoops, S., Sahle, S., Gauges, R., Lee, C., Pahle, J., Simus, N., Singhal, M., Xu, L., Mendes, P. and Kummer, U. (2006) COPASI—a COmplex PAthway SImulator, Bioinformatics, 22, 3067-3074.
Hucka, M., Finney, A., Sauro, H. M., Bolouri, H., Doyle, J. and Kitano, H. (2002) The ERATO Systems Biology Workbench: enabling interaction and exchange between software tools for computational biology, Pac Symp Biocomput, 450-461.
Jiang, N., Cox, R. D. and Hancock, J. M. (2007) A kinetic core model of the glucose-stimulated insulin secretion network of pancreatic beta cells, Mamm Genome, 18, 508-520.
Joshi-Tope, G., Gillespie, M., Vastrik, I., D'Eustachio, P., Schmidt, E., de Bono, B., Jassal, B., Gopinath, G. R., Wu, G. R., Matthews, L., Lewis, S., Birney, E. and Stein, L. (2005) Reactome: a knowledgebase of biological pathways, Nucleic Acids Res, 33, D428-432.
Kanehisa, M., Goto, S., Hattori, M., Aoki-Kinoshita, K. F., Itoh, M., Kawashima, S., Katayama, T., Araki, M. and Hirakawa, M. (2006) From genomics to chemical genomics: new developments in KEGG, Nucleic Acids Res, 34, D354-357.
Karp, P. D., Ouzounis, C. A., Moore-Kochlacs, C., Goldovsky, L., Kaipa, P., Ahren, D., Tsoka, S., Darzentas, N., Kunin, V. and Lopez-Bigas, N. (2005) Expansion of the BioCyc collection of pathway/genome databases to 160 genomes, Nucleic Acids Res, 33, 6083-6089.
Kim, D., Rath, O., Kolch, W. and Cho, K. H. (2007) A hidden oncogenic positive feedback loop caused by crosstalk between Wnt and ERK pathways, Oncogene, 26, 4571-4579.
Kinzler, K. W. and Vogelstein, B. (1996) Breast cancer. What's mice got to do with it?, Nature, 382, 672.
Klipp, E., Herwig, R., Kowald, A., Wierling, C. and Lehrach, H. (2005) Systems Biology in Practice: Concepts, Implementation and Application. WILEY-VCH, Weinheim.
Kühn, C., Wierling, C., Kühn, A., Klipp, E., Panopoulou, G., Lehrach, H. and Poustka, A. J. (2009) Monte-Carlo analysis of an ODE model of the Sea Urchin Endomesoderm Network, BMC Systems Biology, 3, 83.
Levine, D. A., Bogomolniy, F., Yee, C. J., Lash, A., Barakat, R. R., Borgen, P. I. and Boyd, J. (2005) Frequent mutation of the PIK3CA gene in ovarian and breast cancers, Clin Cancer Res, 11, 2875-2878.
Loew, L. M. and Schaff, J. C. (2001) The Virtual Cell: a software environment for computational cell biology, Trends Biotechnol, 19, 401-406.
Martin, G. M. (2005) Epigenetic drift in aging identical twins, Proc Natl Acad Sci USA, 102, 10413-10414.
McCubrey, J. A., Steelman, L. S., Abrams, S. L., Bertrand, F. E., Ludwig, D. E., Basecke, J., Libra, M., Stivala, F., Milella, M., Tafuri, A., Lunghi, P., Bonati, A. and Martelli, A. M. (2008) Targeting survival cascades induced by activation of Ras/Raf/MEK/ERK, PI3K/PTEN/Akt/mTOR and Jak/STAT pathways for effective leukemia therapy, Leukemia, 22, 708-722.
Mendes, P. (1993) GEPASI: a software package for modelling the dynamics, steady states and control of biochemical and other systems, Comput Appl Biosci, 9, 563-571.
Mendes, P. (1997) Biochemistry by numbers: simulation of biochemical pathways with Gepasi 3, Trends Biochem Sci, 22, 361-363.
Nagata, Y., Lan, K. H., Zhou, X., Tan, M., Esteva, F. J., Sahin, A. A., Klos, K. S., Li, P., Monia, B. P., Nguyen, N. T., Hortobagyi, G. N., Hung, M. C. and Yu, D. (2004) PTEN activation contributes to tumor inhibition by trastuzumab, and loss of PTEN predicts trastuzumab resistance in patients, Cancer Cell, 6, 117-127.
Rahn, T., Ridderstrale, M., Tornqvist, H., Manganiello, V., Fredrikson, G., Belfrage, P. and Degerman, E. (1994) Essential role of phosphatidylinositol 3-kinase in insulin-induced activation and phosphorylation of the cGMP-inhibited cAMP phosphodiesterase in rat adipocytes. Studies using the selective inhibitor wortmannin, FEBS Lett, 350, 314-318.
Raynaud, F. I., Eccles, S., Clarke, P. A., Hayes, A., Nutley, B., Alix, S., Henley, A., Di-Stefano, F., Ahmad, Z., Guillard, S., Bjerke, L. M., Kelland, L., Valenti, M., Patterson, L., Gowan, S., de Haven Brandon, A., Hayakawa, M., Kaizawa, H., Koizumi, T., Ohishi, T., Patel, S., Saghir, N., Parker, P., Waterfield, M. and Workman, P. (2007) Pharmacologic characterization of a potent inhibitor of class I phosphatidylinositide 3-kinases, Cancer Res, 67, 5840-5850.
Rhodes, C. J. and White, M. F. (2002) Molecular insights into insulin action and secretion, Eur J Clin Invest, 32 Suppl 3, 3-13.
Saltiel, A. R. and Kahn, C. R. (2001) Insulin signalling and the regulation of glucose and lipid metabolism, Nature, 414, 799-806.
Schubbert, S., Shannon, K. and Bollag, G. (2007) Hyperactive Ras in developmental disorders and cancer, Nat Rev Cancer, 7, 295-308.
Slepchenko, B. M., Schaff, J. C., Macara, I. and Loew, L. M. (2003). Quantitative cell biology with the Virtual Cell, Trends Cell Biol, 13, 570-576.
Strumberg, D. (2005) Preclinical and clinical development of the oral multikinase inhibitor sorafenib in cancer treatment, Drugs Today (Barc), 41, 773-784.
Tomita, M., Hashimoto, K., Takahashi, K., Shimizu, T. S., Matsuzaki, Y., Miyoshi, F., Saito, K., Tanida, S., Yugi, K., Venter, J. C. and Hutchison, C. A., 3rd (1999) E-CELL: software environment for whole-cell simulation, Bioinformatics, 15, 72-84.
Van Ummersen, L., Binger, K., Volkman, J., Marnocha, R., Tutsch, K., Kolesar, J., Arzoomanian, R., Alberti, D. and Wilding, G. (2004) A phase I trial of perifosine (NSC 639966) on a loading dose/maintenance dose schedule in patients with advanced cancer, Clin Cancer Res, 10, 7450-7456.
Vastrik, I., D'Eustachio, P., Schmidt, E., Joshi-Tope, G., Gopinath, G., Croft, D., de Bono, B., Gillespie, M., Jassal, B., Lewis, S., Matthews, L., Wu, G., Birney, E. and Stein, L. (2007) Reactome: a knowledge base of biologic pathways and processes, Genome Biol, 8, R39.
Vivanco, I. and Sawyers, C. L. (2002) The phosphatidylinositol 3-Kinase AKT pathway in human cancer, Nat Rev Cancer, 2, 489-501.
Weinberg, R. A. (2007) The Biology of Cancer. Garland Science, New York.
Wierling, C., Herwig, R. and Lehrach, H. (2007) Resources, standards and tools for systems biology, Brief Funct Genomic Proteomic, 6, 240-251.
Yuan, L., Ziegler, R. and Hamann, A. (2003) Metformin modulates insulin post-receptor signaling transduction in chronically insulin-treated Hep G2 cells, Acta Pharmacol Sin, 24, 55-60.

### EXAMPLE 4

### Generating Computational Predictions Using Kinetic Data of Drug Action

The Monte Carlo strategy according to the invention can be refined by the use of supporting data about drug action such as kinetic binding constants of the drug to the respective enzymes (e.g. kinases, phosphatases) of the system/model. For instance, kinetic data on binding constants as provided in Karaman et al. (2008) can be considered as follows.

$$[ EI ] {{{}_{}}_{{k}_{- 1}}}^{{k}_{1}} [ E ] + [ I ]$$

For the given reaction where [EI] is the concentration of the enzyme/inhibitor complex and [E] and [I] are the concentrations of the concentrations of free enzyme and inhibitor each, the ratio between the inhibited and free enzyme in the steady state is given by the dissociation constant as follows:

$${k}_{D} = \frac{[ E ] [ I ]}{[ EI ]} = \frac{{k}_{1}}{{k}_{- 1}}$$

Where k₁ and k_{_{—}}₋₁ are the kinetic constants of the dissociation respective association reaction. K_{D} is the dissociation constant.

If GE is the total kinase concentration of free and inhibited enzyme, the concentration of the free enzyme y can be calculated by

$$⇒ y = \frac{{k}_{D} * GE}{I + {k}_{D}}$$

If the concentration of the inhibitor is high compared to the concentration of each kinase, this formula can be applied for any kinase that can be inhibited by the drug.

If the overall concentration of the inhibitor is in the same range as the concentrations of the kinases in the cell, one has to take into account also the amount of inhibitor that is bound to the individual kinases.

1. A computer-implemented method of producing a kinetic model of a biological network, the method comprising:
(a) choosing a network topology, wherein the nodes of said topology represent biological entities and the edges of said topology represent interactions between said entities;
(b) assigning kinetic laws and kinetic constants to said interactions; and
(c) assigning starting concentrations to said biological entities, wherein
(i) one part of said kinetic constants and independently one part of said starting concentrations are experimental data; and
(ii) the remaining part of said kinetic constants and independently the remaining part of said starting concentrations are chosen randomly.

2. A method of predicting concentrations of biological entities as a function of time in a biological network, said method comprising producing a model of a biological network by the method of claim 1 said method further comprising;
(d) solving a system of differential equations, said differential equations defining the time-dependency of the concentrations of said biological entities;
thereby obtaining said concentrations as a function of time.

3. The method of claim 2, wherein said remaining part of said kinetic constants is chosen from a probability distribution and independently said remaining part of said starting concentrations is chosen from a probability distribution.

4. The method of claim 3, wherein said distribution is a lognormal, a uniform, an exponential, a Poisson, a Binomial, a Cauchy, a Beta or a Gaussian distribution.

5. The method of claim 2, wherein randomly choosing said remaining part of said kinetic constants, randomly choosing said remaining part of said starting concentrations, and subsequently solving said system of differential equations is performed repeatedly.

6. The method of claim 2, wherein
(e) said method is concomitantly performed on one or more further biological networks; and
(f) the concentrations of biological entities are exchanged between the biological networks at chosen time points.

7. The method of claim 2, wherein one part of said kinetic laws is known, and the remaining part of said kinetic laws is chosen randomly.

8. The method of claim 2, wherein the concentrations of said biological entities are perturbed as compared to the wild type.

9. The method of claim 8, wherein the perturbed concentrations are experimentally determined concentrations.

10. The method of claim 9, wherein said concentrations are determined in knock-down or overexpression experiments, or in diseased states, or in-vitro or cellular drug inhibition experiments.

11. The method of claim 2, wherein initial conditions comprise:
(a) experimentally determined concentrations of biological entities; and/or
(b) experimentally determined mutation data.

12. A computer-implemented method of determining the statistical significance of the method of claim 2, said method comprising:
(a) performing the method of claim 2;
(b) determining the degree of agreement between concentrations of biological entities obtained in step (a) and experimentally determined concentrations for the same biological entities;
(c) randomizing the topology of said biological network;
(d) performing the method of claim 2 on the randomized biological network obtained in step (b);
(e) determining the degree of agreement between concentrations of biological entities obtained in step (d) and experimentally determined concentrations for the same biological entities;
(f) comparing the results obtained in step (b) with those obtained in step (e), wherein a higher degree of agreement in step (b) is indicative of the method of claim 2 being capable to predict experimentally determined concentrations better than by chance.

13. The method according to claim 12, wherein randomizing according to (c) is effected by swapping edges of said network.

14. The method of claim 2, wherein said entities are biomolecules, preferably selected from nucleic acids including genes; (poly)peptides including proteins; small molecules; and complexes and metabolites thereof.

15. The method of claim 2, wherein said model comprises boundary conditions, preferably boundary conditions representing a physiological state.

16. A computer-implemented method of determining partially unknown parameters of a biological network, said parameters being selected from network topology, kinetic laws, kinetic constants and/or starting concentrations, said method comprising minimising the difference between observed and predicted properties, wherein said predicted properties comprise the concentrations as predicted by the method of claim 2.

17. A computer-implemented method of selecting one or more experiments, the method comprising
(a) performing a plurality of experiments in silico by performing the method of predicting concentrations of biological entities according to claim 2, wherein said performing is done for each experiment repeatedly with different choices of unknown parameters, said parameters being selected from network topology, kinetic laws, kinetic constants and/or starting concentrations; and
(b) selecting, out of said plurality of experiments, those one or more experiments for which said method of predicting concentrations of biological entities yields, depending on said different choices, the greatest variance of predicted concentrations.

18. A computer program adapted to perform the method of claim 2.

19. A computer-readable data carrier comprising the program of claim 18.

20. A data processing apparatus comprising means for performing the method of claim 2 or having the program according to claim 18 installed thereon.
